(19) United States
(12) Patent Application Publication
(10) Pub. No.: US 2026/0347644 A1
(43) Pub. Date: Nov. 5, 2026

(54) AQUEOUS COATING MATERIAL CONTAINING CELLULOSE NANOFIBERS

(71) Applicant: BASF COATINGS GMBH, Muenster (DE)

(72) Inventors: Andreas POPPE, Muenster (DE); Marc THOMAS, Muenster (DE); Sebastian CZURA, Muenster (DE); Mizuki YAMADA, Tokyo (JP)

(21) Appl. No.: 19/102,877

(22) PCT Filed: Sep. 1, 2023
(86) PCT No.: PCT/EP23/74065

§ 371 Date: Feb. 11, 2025

(30) Foreign Application Priority Data
Sep. 5, 2022 (EP) 22193934.1

(51) Int. Cl. C09D 153/00; B05D 1/04; B05D 5/06; B05D 7/00; C08K 3/04; C08K 3/08; C08K 3/22; C08K 5/092; C09D 5/02; C09D 7/40; C09D 7/41; C09D 7/61; C09D 7/63; C09D 7/65; C09D 175/04

(52) U.S. Cl. CPC C09D 153/00; B05D 1/04; B05D 5/066; B05D 7/574; B05D 7/577; C08K 3/04; C08K 5/092; C09D 5/028; C09D 7/41; C09D 7/61; C09D 7/63; C09D 7/65; C09D 7/70; C09D 175/04; B05D 2202/15; B05D 2320/00; B05D 2401/20; B05D 2451/00; B05D 2503/00; B05D 2520/00; C08K 2003/0812; C08K 2003/2241

(57) ABSTRACT

Described herein is an aqueous coating material including one or more polymeric binders; one or more types of cellulose nanofibers; and one or more non-polymeric polycarboxylic acid and/or the salt(s) thereof, and optionally including one or more pigments. Also described herein is a wet-on-wet method of producing multilayer coating systems and the multilayer coating systems obtainable according to the method. Also described herein is the method of using the non-pigmented aqueous coating material for the production of the pigmented aqueous coating material; and the of at least one type of cellulose nanofibers together with one or more non-polymeric polycarboxylic acids and/or their salts in an aqueous coating material including polymeric binders and pigments, in the production of a multilayer coating system.

The present invention relates to a polymeric binder containing aqueous coating material further containing one or more types of cellulose nanofibers and one or more non-polymeric polycarboxylic acids and/or their salts. The invention further relates to a method of producing a multilayer coating on a substrate, wherein the aqueous coating compositions are used as pigmented basecoat material, preferably in automotive coating. The invention further relates to the thus obtained multilayer coating system, Moreover, the present invention relates to the use of cellulose nanofibers and non-polymeric polycarboxylic acids in polymeric binder and pigment containing aqueous coating materials and the use of the coating materials as basecoat materials in the production of multilayer coating systems.

### BACKGROUND

Particularly in automotive finishing, but also in other sectors where there is a desire for coatings with high decorative effect and at the same time effective protection from corrosion, it is known practice to provide substrates with a plurality of coating layers disposed one above another.

Multicoat paint systems are applied preferably by what is called the “wet-on-wet” method, meaning that a pigmented basecoat material is applied first and is recoated, after a short flashing time, without a baking step, with clearcoat material. Subsequently, basecoat and clearcoat are jointly baked. The “wet-on-wet” method has acquired particular significance in the application of automotive color and/or metallic effect paints.

Economic and environmental reasons have led to the development of multicoat systems making use of aqueous basecoat materials. The coating materials for producing these basecoats must be capable of being processed by the nowadays customary, rational “wet-on-wet” method; that is, following a very short initial drying period, without a baking step, they must be capable of being recoated with a transparent topcoat, without exhibiting defects in their visual appearance.

Furthermore, the coating material must also exhibit sufficient stability on storage. A customary test is the storage of the material at 40 °C followed by the determination of any viscosity change after storage. Particularly basecoat materials containing color pigments and/or effect pigments such as metal effect pigments should be storage stable, since otherwise a settlement of the pigment particles will occur.

With metallic effect paints for use in the “wet-on-wet” method, there are further problems that must be solved. The metallic effect is critically dependent on the dispersing of the metallic pigment particles in the coating material, the size and shape of the metallic pigment particles, rheological properties of the coating material, application of the coating material, and the orientation of the metallic pigment particles in the coating layer. A metallic effect basecoat material which can be processed by the “wet-on-wet” method, accordingly, must provide coating layers in which the metallic pigments, following application, are present in a favorable spatial orientation, and in which this orientation is fixed so quickly that it can no longer be negatively influenced in the course of the further finishing operation.

Suitable parameters for characterizing a metallic effect basecoat are the light reflection, particularly the directional change in light reflection which is typically expressed in term of the flop index. Metallic effect basecoats exhibiting a low flop index appear uniform when viewed from several angles and on curved surfaces. To achieve a low flop index, the metallic effect pigments must exhibit a random orientation within the basecoat.

However, there is still an increase in the popularity of metallic effect basecoats featuring a high flop index. Coats of this kind take on different appearances when viewed from different angles and on curved surfaces. To achieve a high flop index, the metallic effect pigments within the basecoat must exhibit a substantially parallel orientation to the underlying substrate.

One way of achieving a high flop index is to apply a composition containing metallic effect pigment, with a low nonvolatile fraction, by hand. Application by hand, however, limits the use of such compositions in vehicle production and OEM vehicle finishing.

Also known from the prior art is the practice of raising the flop index by adding polyamide waxes with different acid numbers. For example, EP 0877063 A2, WO 2009/100938 A1, EP 2457961 A1, and EP 3183303 A1 describe aqueous coating materials which comprise a polyamide having an acid number of 30 mg KOH/g polyamide or of <10 mg KOH/g polyamide. The use of polyamides and other water-insoluble constituents in aqueous coating materials, however, can lead to incompatibility between these compounds and the water-soluble constituents of the compositions. This results in particular in bittiness on processing by the “wet-on-wet” method and/or on incorporation of the polyamide into the coating materials, and/or in inadequate storage stability (demixing or phase separation) of such coating materials, particularly at relatively high temperatures such as, for example, temperatures of about 40 °C. In addition, polyamides may cause poor leveling and/or a poor appearance.

EP 1153989 A1 discloses aqueous coating materials which comprise a polyamide having an acid number≥30 mg KOH/g of the polyamide and, as a further rheological assistant, a metal silicate consisting of very small, usually nanoscale, particles. A disadvantage of the presence of such a metal silicate, however, especially in combination with a polyamide having an acid number>30 mg KOH/g polyamide, in aqueous coating materials may often be the incidence of pinholes and/or pops in the case of processing by means of the “wet-on-wet” method. Furthermore, the use of metal silicates is undesirable, since on account of their high surface area they enter into strong interactions with other formulation constituents, especially dispersing additives and/or binders having groups with pigment affinity. Minimizing these interactions requires a high level of dilution. That dilution, however, may negatively influence, in particular, the shear stability and the circulation line stability of the coating material.

Another approach to produce rheology stable coating materials is, e.g., disclosed in U.S. Pat. No. 10,898,923 B2 wherein the use of cellulose nanofibers in aqueous effect pigment formulations is described. However, those formulations are limited to maximum solids contents of 10% by weight, based on the total weight of the coating material.

The aims of the present invention were to provide aqueous coating materials allowing solids contents of more than 10% by weight based on the total weight of the coating material. The aqueous coating materials should possess an excellent storage stability and viscosity stability, even without using rheology control agents from the group consisting of polyamides and metal silicates. Particularly, the aqueous coating materials to be provided by the present invention should be apt to be supplemented with color pigments and/or effect pigments alike to form pigmented aqueous coating materials possessing storage stability and viscosity stability.

Furthermore, particularly if used as a pigmented basecoat material in a multilayer coating system, such coating material should provide good optical and coloristic properties to the multilayer coating as well as good levelling characteristics and in case of metal effect pigment containing coating materials an improved flop. Preferably the aqueous coating materials of the present invention are apt to be applied in so-called wet-on-wet coating methods and are suitable in automotive coating.

### SUMMARY

The aims are achieved by providing an aqueous coating material comprising
a) one or more polymeric binders
b) one or more types of cellulose nanofibers; and
c) one or more non-polymeric polycarboxylic acid and/or the salt(s) thereof and
d) optionally comprising one or more pigments.

The afore-mentioned aqueous coating material is hereinafter also referred to as “aqueous coating material of the invention” or “aqueous coating material according to the invention”.

Further subject of the present invention is a method for producing a multicoat paint system on a substrate, the method comprising the following steps:
(1) optionally producing a cured first coating layer on the substrate by application of a coating material to the substrate and subsequent curing of the composition;
(2) producing one or more basecoat layers on the coating layer obtained in step (1) by application of one or more identical or different aqueous basecoat material;
(3) producing one or more clearcoat layers one the one or the topmost basecoat layer by application of a clearcoat material; and
(4) jointly curing the one or more basecoat layers and the one or more clearcoat layers;
wherein
at least one of the basecoat materials is an aqueous coating material according to the invention.

The afore-mentioned method for producing a multicoat paint system on a substrate is hereinafter also referred to as “method of the invention” or “method according to the invention”.

The invention further provides a multilayer coating system obtainable by the method of the invention.

A further subject of the present invention is the use of a non-pigmented aqueous coating material according to the present invention as universal aqueous coating composition for the production of the pigmented aqueous coating material of the present invention.

Yet another subject of the present invention is the use of at least one type of cellulose nanofibers as used in the aqueous coating material of the invention together with one or more non-polymeric polycarboxylic acids and/or their salts as use in the aqueous coating material of the invention, in an aqueous coating material comprising one or more polymeric binders as in the aqueous coating material of the invention and one or more pigments as defined above and below, in the production of a multilayer coating system.

Further subject of the present invention is the use of the pigmented aqueous coating materials of the present invention as basecoat materials, preferably in automotive coating.

### DETAILED DESCRIPTION

### Aqueous Coating Materials

The term “coating material” refers to a product in liquid, paste or powder form, that, when applied to a substrate, forms a film possessing protective, decorative and/or other specific properties (DIN ISO 4618:2006). The expression “aqueous coating material” is known to the skilled person. It refers fundamentally to a liquid coating material the volatile content of which is not based exclusively on organic solvents.

Indeed, any such coating material based on organic solvents contains exclusively organic solvents and no water for dissolving and/or dispersing the components, or is a coating material for which no water is added explicitly during its production, water entering the composition instead only in the form of contaminant, atmospheric moisture and/or solvent for any specific additives employed. Such a composition, in contrast to an aqueous coating material, would be referred to as being solvent-based or “based on organic solvents”.

“Aqueous” in the context of the present invention should be understood preferably to mean that the coating material comprises a water fraction of at least 20 wt.-%, preferably at least 25 wt.-%, very preferably at least 50 wt.-%, based in each case on the total amount of the solvents present (that is, water and organic solvents). The water fraction in turn is preferably 60 to 100 wt.-%, more particularly 65 to 90 wt.-%, very preferably 70 to 80-wt.-%, based in each case on the total amount of the solvents present.

The coating material of the invention has a relatively high solids content. It is therefore preferred if the composition has a solids content of 10 or 11 to 65 wt.-%, preferably of 15 to 50 wt.-%, more particularly of 20 to 45 wt.-%, based in each case on the total weight of the coating material and measured according to DIN EN ISO 3251 (June 2008) as detailed in the Examples section of this specification. In light of the high solids content, the coating materials of the invention have a good environmental profile without any adverse effect, though, on their storage stability.

The coating material of the invention preferably has a pH in the range of 4 to 10, more preferred in the range of 5 to 10, even more preferred in the range of 7 to 10, more particularly of 7 to 9, measured in each case at 23 °C.

Preferably the aqueous coating materials of the present invention are pigmented, thus comprising one or more pigments selected from the group consisting of color pigments and effect pigments.

More preferably the aqueous coating materials of the present invention are pigmented basecoat materials, particularly preferred for automotive coatings.

### Polymeric Binders

The term “binder” in the sense of the present invention and in agreement with DIN EN ISO 4618 (German version, date: March 2007), refers preferably to those nonvolatile fractions of the composition of the invention that are responsible for forming the film, with the exception of any pigments and fillers therein, and more particularly refers to the polymeric resins which are responsible for film formation. The nonvolatile fraction may be determined by the method described in the Examples section.

The curing of a coating layer is understood accordingly to be the conversion of such a layer into the service-ready state, in other words into a state in which the substrate furnished with the coating layer in question can be transported, stored, and used in its intended manner. A cured coating layer, then, is in particular no longer soft or tacky, but instead is conditioned as a solid coating layer which, even on further exposure to curing conditions as described later on below, no longer exhibits any substantial change in its properties such as hardness or adhesion to the substrate.

As is known, coating materials may in principle be cured physically and/or chemically, depending on components present particularly polymeric binders and crosslinking agent, which belong to the binders as well.

In the case of chemical curing, consideration is given to thermochemical curing and actinic-chemical curing. Where, for example, a coating material is thermochemically curable, it may be self-crosslinking and/or externally crosslinking. The indication that a coating material is self-crosslinking and/or externally crosslinking means, in the context of the present invention, that this coating material comprises polymers as binders and optionally crosslinking agents as binders that are able to crosslink with one another correspondingly. The parent mechanisms and also binders and crosslinking agents as binders (i.e., film-forming components) that can be used are described later on below.

In the context of the present invention, “physically curable” or the term “physical curing” means the formation of a cured coating layer by loss of solvent from polymer solutions or polymer dispersions, with the curing being achieved inter alia by interlooping of polymer chains. Coating materials of these kinds are generally formulated as one-component coating materials.

In the context of the present invention, “thermochemically curable” or the term “thermochemical curing” means the crosslinking of a coating layer (formation of a cured coating layer) initiated by chemical reaction of reactive functional groups, where the energetic activation of this chemical reaction is possible through thermal energy. Different functional groups which are complementary to one another can react with one another here (complementary functional groups), and/or the formation of the cured coat is based on the reaction of autoreactive groups, in other words functional groups which react among one another with groups of their own kind. Examples of suitable complementary reactive functional groups and autoreactive functional groups are, e.g., known from German patent application DE 199 30 665 A1, page 7, line 28, to page 9, line 24.

In thermochemically curable one-component systems, the components for crosslinking, as for example organic polymers as binders and crosslinking agents as binders, are present alongside one another, in other words in one component. A requirement for this is that the components to be crosslinked effectively react with one another—that is, enter into curing reactions—only at relatively high temperatures of typically more than 100 °C, for example. As an exemplary combination, mention may be made of hydroxy-functional polyesters and/or polyurethanes with melamine resins and/or blocked polyisocyanates as crosslinking agents.

In thermochemically curable two-component systems, the components that are to be crosslinked, as for example the organic polymers as binders and the crosslinking agents, are present separately from one another in at least two components, which are not combined until shortly before application. This form is selected when the components for crosslinking undergo effective reaction with one another even at ambient temperatures, such as 20 °C or slightly elevated temperatures of 40 to 90 °C, for example. As an exemplary combination, mention may be made of hydroxy-functional polyesters and/or polyurethanes and/or poly(meth)acrylates with free polyisocyanates as crosslinking agent.

In the context of the present invention, “actinic-chemically curable”, or the term “actinic-chemical curing”, refers to the fact that the curing is also possible with application of actinic radiation, this being electromagnetic radiation such as near infrared (NIR) and UV radiation, more particularly UV radiation, and also particulate radiation such as electron beams. The curing by UV radiation is initiated customarily by radical or cationic photoinitiators. Typical actinically curable functional groups are carbon-carbon double bonds, with radical photoinitiators generally being employed in that case. Actinic curing, then, is likewise based on chemical crosslinking.

Of course, in the curing of a coating material identified as chemically curable, there will always be physical curing as well, in other words the interlooping of polymer chains. The physical curing may even be predominant. Provided it includes at least a proportion of film-forming components that are chemically curable, nevertheless, a coating material of this kind is identified as chemically curable.

In the case of a purely physically curing coating material, curing takes place preferably between 15 and 90 °C over a period of 2 to 48 hours. In this case, then, the curing differs from the flashing and/or interim drying, where appropriate, solely in the duration of the conditioning of the coating layer. Differentiation between flashing and interim drying, moreover, is not sensible. It would be possible, for example, for a coating layer produced by application of a physically curable coating material to be subjected to flashing or interim drying first of all at 15 to 35 °C for a duration of 0.5 to 30 minutes, for example, and then to be cured at 50 °C for a duration of 5 hours.

In principle, and in the context of the present invention, the curing of thermochemically curable one-component systems can be carried out preferably at temperatures of 100 to 250 °C, preferably 100 to 180 °C, for a duration of 5 to 60 minutes, preferably 10 to 45 minutes, since these conditions are generally necessary in order for chemical crosslinking reactions to convert the coating layer into a cured coating layer. Accordingly, it is the case that a flashing and/or interim drying phase taking place prior to curing takes place at lower temperatures and/or for shorter times. In such a case, for example, flashing may take place at 15 to 35 °C for a duration of 0.5 to 30 minutes, for example, and/or interim drying may take place at a temperature of 40 to 90 °C, for example, for a duration of 1 to 60 minutes, for example.

In principle, and in the context of the present invention, the curing of thermochemically curable two-component systems is carried out at temperatures of 15 to 90 °C, for example, in particular 40 to 90 °C, for a duration of 5 to 80 minutes, preferably 10 to 50 minutes. Accordingly, it is the case that a flashing and/or interim drying phase occurring prior to curing takes place at lower temperatures and/or for shorter times. In such a case, for example, it is no longer sensible to make any distinction between the concepts of flashing and interim drying. A flashing or interim drying phase which precedes curing may take place, for example, at 15 to 35 °C for a duration of 0.5 to 30 minutes, for example, but at any rate at lower temperatures and/or for shorter times than the curing that then follows.

This of course is not to rule out a thermochemically curable two-component system being cured at higher temperatures. For example, in a wet-on-wet coating method of the invention as described with more precision later on below, a basecoat layer or two or more basecoat layers are cured jointly with a clearcoat layer. Where both thermochemically curable one-component systems and two-component systems are present within the layers, a one-component basecoat material and a two-component clearcoat material, for example, the joint curing is of course guided by the curing conditions that are necessary for the one-component system.

All temperatures elucidated in the context of the present invention should be understood as the temperature of the room in which the coated substrate is located. It does not mean, therefore, that the substrate itself is required to have the temperature in question.

Due to the possible use of different curing mechanisms for the aqueous coating material of the present invention, the one or more polymeric binders PB as used in the coating materials of the present invention may differ in their constitution.

Thus, the one or more polymeric binders PD of the present invention can be selected from the group consisting of physically drying polymeric binders, thermochemically curable binders and/or radiation curable binders.

Particularly, the one or more polymeric binders PB are preferably non-ionically and/or anionically stabilized polymeric binders. However, anionically stabilized polymeric binders are more preferred as the one or more polymeric binders PB as used in the aqueous coating materials of the present invention.

### Non-Ionically Stabilized Polymeric Binders

A non-ionic stabilization of polymeric binders in aqueous coatings compositions is typically achieved by incorporating water-soluble non-ionic moieties in the polymeric binder. Such moieties are preferably selected from the group comprising or consisting of poly(oxyalkylene) moieties, polylactone moieties such as polybutyrolactone moieties, polyalcohol moieties, such as polyvinyl alcohol moieties, and also polyvinylpyrrolidone moieties, more particularly poly(oxyethylene) moieties and/or poly(oxypropylene) moieties.

### Anionically Stabilized Polymeric Binders

An anionic stabilization of polymeric binders in aqueous coatings compositions is typically achieved by incorporation of anionic groups into the polymeric binder. Such anionic groups are preferably introduced in form of acidic groups such as carboxylic acid groups and subsequent at least partial neutralization of the acidic groups.

Anionically stabilized polymeric binders are preferred over non-ionically stabilized polymeric binders in the aqueous coating materials of the present invention, because their use leads to multilayer coatings having even better color matching and flop properties in combination with the cellulose nanofibers and non-polymeric polycarboxylic acids.

Particular preference is given to using anionically stabilized polymeric binders which at a pH of 8.0 have a certain electrophoretic mobility. The electrophoretic mobility here may be determined as described in the Examples section. In one preferred embodiment of the present invention, therefore, the at least one anionically stabilized polymeric binder at a pH of 8.0 has an electrophoretic mobility of −2.5 to −15 (μm/s)/(V/cm), preferably of −2.5 to −10 (μm/s)/(V/cm), more preferably of −4 to −8 (μm/s)/(V/cm), more particularly of −5 to −8 (μm/s)/(V/cm).

It is advantageous, furthermore, if the anionically stabilized polymeric binder is present in a defined total amount in the aqueous coating composition of the invention. In one preferred embodiment of the present invention, therefore, the at least one anionically stabilized polymeric binder is present in a total amount of 20 to 80 wt.-%, preferably of 30 to 70 wt.-%, more particularly of 40 to 70 wt.-%, based in each case on the overall solids content of the coating composition. If more than one anionically stabilized polymeric binder is used, then the aforesaid quantity ranges are based on the total amount of anionically stabilized polymeric binders in the composition. The use of the at least one anionically stabilized polymeric binder in the aforesaid quantity ranges leads, in combination with the one or more cellulose nanofibers and the one or more non-polymeric polycarboxylic acid, to a particularly good flop index and also to good optical and coloristic properties in pigmented aqueous basecoat layers, but without adversely affecting the storage stability of the compositions of the invention. Moreover, the use of the aforementioned quantities of anionically stabilized polymeric binder leads to effective fixing of the orientation of the effect particles in effect pigmented aqueous basecoat layers formed from effect pigment containing aqueous coating composition of the present invention during flashing, and so a subsequent application of further coating compositions has no adverse effect on the orientation of the effect particles and hence on the flop index.

### Polyurethane-Polyurea-Particles (PPP)

In the context of the present invention it has proven advantageous if the anionically stabilized polymeric binder comprises anionically stabilized polyurethane-polyurea particles (PPP) in dispersion in water.

Therefore, the anionically stabilized polymeric binder preferably comprises anionically stabilized polyurethane-polyurea particles (PPP) in dispersion in water and having an average particle size of preferably 40 to 2000 nm and a gel fraction of at least 50%, the anionically stabilized polyurethane-polyurea particles (PPP) comprising, in each case in reacted form,
(Z.1.1) at least one isocyanate group-containing polyurethane prepolymer containing groups which are anionic and/or can be converted into anionic groups, and
(Z.1.2.) at least one polyamine containing two primary amino groups and one or two secondary amino groups.

The anionically stabilized polyurethane-polyurea particles (PPP) are in dispersion in water, or present in the form of an aqueous dispersion. The fraction of water in the dispersion is preferably 45 to 75 wt.-%, preferably 50 to 70 wt.-%, more preferably 55 to 65 wt.-%, based in each case on the total amount of the dispersion. It is preferred for the dispersion to consist to an extent of at least 90 wt.-%, preferably at least 92.5 wt.-%, very preferably at least 95 wt.-%, and more preferably at least 97.5 wt.-%, of the polyurethane-polyurea particles (PPP) and water (the associated value is obtained by summating the amount of the particles (that is, of the polymer, determined via the solids content) and the amount of water).

The anionically stabilized polyurethane-polyurea particles (PPP) are polymer particles which are polyurethane-polyurea-based. The anionically stabilized polyurethane-polyurea particles (PPP) preferably possess a gel fraction of at least 50% (for measurement method, see Examples section) and preferably an average particle size (also called mean particle size) of 40 to 2000 nanometers (nm) (for measurement method, see Examples section). The polyurethane-polyurea particles (PPP) therefore constitute a microgel. The reason is that on the one hand the polymer particles are in the form of comparatively small particles, or microparticles, and on the other hand they are at least partly intramolecularly crosslinked. The latter means that the polymer structures present within a particle equate to a typical macroscopic network with a three-dimensional network structure. Viewed macroscopically, however, a microgel of this kind continues to comprise discrete polymer particles.

Because the microgels represent structures which lie between branched and macroscopically crosslinked systems, they combine, consequently, the characteristics of macromolecules with network structure that are soluble in suitable organic solvents, and insoluble macroscopic networks, and so the fraction of the crosslinked polymers can be determined, for example, only following isolation of the solid polymer, after removal of water and any organic solvents, and subsequent extraction. The phenomenon utilized here is that whereby the microgel particles, originally soluble in suitable organic solvents, retain their inner network structure after isolation and behave, in the solid, like a macroscopic network. Crosslinking may be verified via the experimentally accessible gel fraction. Lastly, the gel fraction is that fraction of the polymer in the microgel that cannot be molecularly dispersedly dissolved, as an isolated solid, in a solvent. It is necessary here to rule out a further increase in the gel fraction from crosslinking reactions subsequent to the isolation of the polymeric solid. This insoluble fraction corresponds in turn to the fraction of the polymer that is present in the form of intramolecularly crosslinked particles or particle fractions.

The polyurethane-polyurea particles (PPP) preferably possess a gel fraction of 50%, preferably of at least 60%, more preferably of at least 70%, more particularly of at least 80%. The gel fraction may therefore be up to 100% or nearly 100%, as for example 99% or 98%. In such a case, then, the entire, or almost the entire, polyurethane-polyurea polymer is in the form of crosslinked particles.

The polyurethane-polyurea particles (PPP) possess an average particle size of 40 to 2000 nm preferably of 40 to 1500 nm, more preferably of 100 to 1000 nm, more preferably still of 110 to 500 nm, more particularly of 120 to 300 nm. An especially preferred range is from 130 to 250 nm.

The polyurethane-polyurea particles (PPP) comprise, in each case in reacted form,
(Z.1.1) at least one polyurethane prepolymer containing isocyanate groups and containing groups which are anionic and/or can be converted into anionic groups, and also
(Z.1.2) at least one polyamine containing two primary amino groups and one or two secondary amino groups.

The expression “the polyurethane-polyurea particles (PPP) comprise, in each case in reacted form, a polyurethane prepolymer (Z.1.1) and a polyamine (Z.1.2)” here means that an aforesaid NCO-containing polyurethane prepolymer (Z.1.1) and also a polyamine (Z.1.2) were used in preparing the polyurethane-polyurea particles (PPP) and that these two components react with one another to form urea compounds.

The polyurethane-polyurea particles (PPP) preferably consist of the two components (Z.1.1) and (Z.1.2), meaning that they are prepared from these two components. The polyurethane-polyurea particles (PPP) in dispersion in water may be obtained, for example, by a specific three-stage process.

In a first step (I) of this process, a composition (Z) is prepared.

The composition (Z) comprises at least one, preferably precisely one, specific intermediate (Z.L) containing isocyanate groups and blocked primary amino groups. The preparation of the intermediate (Z.1) comprises the reaction of at least one polyurethane prepolymer (Z.1.1) containing isocyanate groups and groups which are anionic and/or can be converted into anionic groups, with at least one compound (Z.1.2a) which is derived from a polyamine (Z.1.2) and contains at least two blocked primary amino groups and at least one free secondary amino group.

For the purposes of the present invention, the component (Z.1.1) is referred to, for ease of comprehension, as a prepolymer.

The prepolymers (Z.1.1) comprise groups which are anionic and/or can be converted into anionic groups (that is, groups which can be converted into anionic groups through the use of neutralizing agents which are known and also specified later on below, such as bases). As the skilled person is aware, these groups are, for example, carboxylic, sulfonic and/or phosphonic acid groups, more particularly carboxylic acid groups (functional groups which can be converted into anionic groups by neutralizing agents), and also anionic groups derived from the aforementioned functional groups, such as, more particularly, carboxylate, sulfonate and/or phosphonate groups, preferably carboxylate groups. Introducing such groups is known to increase the dispersibility in water. Depending on the conditions selected, the stated groups may be present proportionally or almost completely in the one form (carboxylic acid, for example) or the other form (carboxylate), through the use, for example, of neutralizing agents that are described later on below.

To introduce the stated groups it is possible, during the preparation of the prepolymers (Z.1.1), to use starting compounds which as well as groups for reaction in the preparation of urethane bonds, preferably hydroxyl groups, further comprise the abovementioned groups, carboxylic acid groups for example. In this way the groups in question are introduced into the prepolymer.

Corresponding compounds contemplated for introducing the preferred carboxylic acid groups include—insofar as they contain carboxyl groups—polyether polyols and/or polyester polyols. Used with preference, however, are in any case low molecular mass compounds which have at least one carboxylic acid group and at least one functional group that is reactive toward isocyanate groups—hydroxyl groups, preferably. The expression “low molecular mass compound” means in the context of the present invention that the compounds in question have a molecular weight of less than 300 g/mol. The range from 100 to 200 g/mol is preferred. Examples of compounds preferred in this sense are monocarboxylic acids containing two hydroxyl groups, such as dihydroxypropionic acid, dihydroxysuccinic acid, and dihydroxybenzoic acid, for example. More particularly they are α,α-dimethylolalkanoic acids such as 2,2-dimethylolacetic acid, 2,2-dimethylolpropionic acid, 2,2-dimethylolbutyric acid, and 2,2-dimethylolpentanoic acid, especially 2,2-dimethylolpropionic acid.

The prepolymers (Z.1.1) therefore preferably contain carboxylic acid groups. Based on the solids content, they possess preferably an acid number of 10 to 30 mg KOH/g, more particularly 15 to 23 mg KOH/g (for measurement method, see Examples section).

The prepolymers (Z.1.1) are prepared preferably by reaction of diisocyanates with polyols. Examples of suitable polyols are saturated or olefinically unsaturated polyester polyols and/or polyether polyols as described for example in WO 2018/011311 A1 and WO 2016/091546 A1. Polyols used with preference for preparing the prepolymers (Z.1.1) are polyester diols which have been prepared using dimer fatty acids. Especially preferred are polyester diols prepared using dicarboxylic acids of which at least 50 wt.-%, preferably 55 to 75 wt.-%, of those used are dimer fatty acids.

Dimer fatty acids are oligomers of forms of unsaturated monomeric fatty acids. Fatty acids are saturated or unsaturated, especially unbranched, monocarboxylic acids having 8 to 64 carbon atoms.

Additionally for preparing the polymers (Z.1.1) it is also possible to use polyamines such as diamines and/or amino alcohols. Examples of diamines include hydrazine, alkyl- or cycloalkyldiamines such as propylenediamine and 1-amino-3-aminomethyl-3,5,5-trimethylcyclohexane, and examples of amino alcohols include ethanolamine or diethanolamine.

With regard to the polyisocyanates suitable for preparing the polyurethane prepolymers (Z.1.1) containing isocyanate groups, reference is made to the laid-open specifications WO 2018/011311 A1 and WO 2016/091546 A1. Preferred is the use of aliphatic diisocyanates, such as hexamethylene diisocyanate, isophorone diisocyanate (IPDI), dicyclohexylmethane 4,4′-diisocyanate, 2,4- or 2,6-diisocyanato-1-methylcyclohexane and/or m-tetramethylxylylene diisocyanate (m-TMXDI).

The number-average molecular weight of the prepolymers may vary widely and be situated for example in the range from 2000 to 20 000 g/mol, preferably from 3500 to 6000 g/mol (for measurement method, see Examples section).

The prepolymer (Z.1.1) contains isocyanate groups. Based on the solids content, it preferably possesses an isocyanate content of 0.5 to 6.0 wt.-%, preferably 1.0 to 5.0 wt.-%, especially preferably 1.5 to 4.0 wt.-% (for measurement method, see Examples section).

The hydroxyl number of the prepolymer, based on the solids content, is preferably less than 15 mg KOH/g, more particularly less than 10 mg KOH/g, more preferably still less than 5 mg KOH/g (for measurement method, see Examples section).

The prepolymers (Z.1.1) may be prepared as described in WO 2018/011311 A1 and WO 2016/091546 A1.

As already indicated above, the groups which are present in the prepolymer (Z.1.1) and can be converted into anionic groups may also be present proportionally as correspondingly anionic groups, through the use of a neutralizing agent, for example. In this way it is possible to adjust the water dispersibility of the prepolymers (Z.1.1) and hence also of the intermediate (Z.1). Neutralizing agents contemplated include in particular the known basic neutralizing agents such as, for example, carbonates, hydrogen carbonates or hydroxides of alkali metals and alkaline earth metals, such as, for example LiOH, NaOH, KOH or Ca(OH)₂. Also suitable for the neutralization and preferred in the context of the present invention for use are organic, nitrogen-containing bases such as amines like ammonia, trimethylamine, triethylamine, tributylamines, dimethylaniline, triphenylamine, dimethylethanolamine, methyldiethanolamine or triethanolamine, and also mixtures thereof.

If neutralization of the groups—particularly the carboxylic acid groups—which can be converted into anionic groups is desired, the neutralizing agent may be added, for example, in an amount such that a fraction of 35% to 65% of the groups is neutralized (degree of neutralization). Preferred is a range from 40% to 60% (for calculation method, see Examples section).

The compound (Z.1.2a) comprises two blocked primary amino groups and one or two free secondary amino groups.

Blocked amino groups, as is known, are those in which the hydrogen radicals on the nitrogen that are present inherently in free amino groups have been substituted by reversible reaction with a blocking agent. In view of the blocking, the amino groups cannot be reacted like free amino groups, via condensation or addition reactions, and in this respect are therefore nonreactive and so differ from free amino groups. The primary amino groups of the compound (Z.1.2a) may be blocked with the blocking agents that are known per se, as for example with ketones and/or aldehydes. In the case of such blocking, ketimines and/or aldimines are then produced, with release of water. Groups of this kind can be unblocked with addition of water.

If an amino group is specified neither as being blocked nor as being free, the reference is to a free amino group.

Preferred blocking agents for blocking the primary amino groups of the compound (Z.1.2a) are ketones. Particularly preferred among the ketones are those which are an organic solvent (Z.2) as described later on below. The reason is that this solvent (Z.2) must in any case be present in the composition (Z) to be prepared in stage (1) of the method. Through the use of ketones (Z.2) for blocking, the correspondingly preferred production process for blocked amines can therefore be employed, without the possibly unwanted blocking agent having to be separated off, at cost and inconvenience. Instead, the solution of the blocked amine can be used directly for preparing the intermediate (Z.1). Preferred blocking agents are acetone, methyl ethyl ketone, methyl isobutyl ketone, diisopropyl ketone, cyclopentanone or cyclohexanone; particularly preferred are the ketones (Z.2) methyl ethyl ketone and methyl isobutyl ketone.

The preferred blocking with ketones and/or aldehydes, especially ketones, and the associated preparation of ketimines and/or aldimines, have the advantage, moreover, that primary amino groups are blocked selectively. Secondary amino groups present are evidently unable to be blocked, and therefore remain free. Consequently, the compound (Z.1.2a) which as well as the two blocked primary amino groups also comprises one or two free secondary amino groups can be prepared readily by way of the stated preferred blocking reactions from a corresponding polyamine (Z.1.2) which contains free secondary and primary amino groups.

The compounds (Z.1.2a) preferably possess two blocked primary amino groups and one or two free secondary amino groups, and the primary amino groups they possess are exclusively blocked primary amino groups, and the secondary amino groups they possess are exclusively free secondary amino groups.

The compounds (Z.1.2a) preferably possess a total of three or four amino groups, these being selected from the group of blocked primary amino groups and of free secondary amino groups.

Especially preferred compounds (Z.1.2a) are those which consist of two blocked primary amino groups, one or two free secondary amino groups, and also aliphatically saturated hydrocarbon groups.

Analogous preferred embodiments are valid for the polyamines (Z.1.2), with these polyamines then containing free primary amino groups rather than blocked primary amino groups. Examples of preferred polyamines (Z.1.2), from which it is also possible to prepare compounds (Z.1.2a) by blocking of the primary amino groups, are diethylenetriamine, 3-(2-aminoethyl) aminopropylamine, dipropylenetriamine, and also N1-(2-(4-(2-aminoethyl)piperazin-1-yl)ethyl)-ethane-1,2-diamine (one secondary amino group, two primary amino groups to be blocked) and triethylenetetramine, and also N,N′-bis(3-aminopropyl)ethylenediamine (two secondary amino groups, two primary amino groups to be blocked).

If a certain quantity of a polyamine is blocked, the blocking may result for example in a fraction of 95 mol % or more of the primary amino groups becoming blocked (this fraction can be determined by IR spectroscopy; see Examples section). Where, for example, a polyamine in the unblocked state possesses two free primary amino groups, and where the primary amino groups of a certain amount of this amine are then blocked, it is said in the context of the present invention that this amine has two blocked primary amino groups if a fraction of more than 95 mol % of the primary amino groups present in the amount employed are blocked.

The preparation of the intermediate (Z.1) comprises the reaction of the prepolymer (Z.1.1) with the compound (Z.1.2a) by addition reaction of isocyanate groups from (Z.1.1) with free secondary amino groups from (Z.1.2a). This reaction, which is known per se, then leads to the attachment of the compound (Z.1.2a) onto the prepolymer (Z.1.1) to form urea bonds, ultimately giving the intermediate (Z.1).

The intermediate (Z.1) may be prepared as described in WO 2018/011311 A1 and WO 2016/091546 A1.

The fraction of the intermediate (Z.1) is from 15 to 65 wt.-%, preferably from 25 to 60 wt.-%, more preferably from 30 to 55 wt.-%, especially preferably from 35 to 52.5 wt.-%, and, in one very particular embodiment, from 40 to 50 wt.-%, based in each case on the total amount of the composition (Z).

The composition (Z) further comprises at least one specific organic solvent (Z.2). The solvents (Z.2) at a temperature of 20 °C possess a solubility in water of at most 38 wt.-% (for measurement method, see Examples section). The solubility in water at a temperature of 20 °C is preferably less than 30 wt.-%. A preferred range is from 1 to 30 wt.-%. Accordingly, the solvent (Z.2) possesses a fairly moderate solubility in water, and more particularly is not completely miscible with water, or possesses no unlimited solubility in water.

Examples of solvents (Z.2) are methyl ethyl ketone, methyl isobutyl ketone, diisobutyl ketone, diethyl ether, dibutyl ether, dipropylene glycol dimethyl ether, ethylene glycol diethyl ether, toluene, methyl acetate, ethyl acetate, butyl acetate, propylene carbonate, cyclohexanone, or mixtures of these solvents. Preferred is methyl ethyl ketone, which at 20 °C has a solubility in water of 24 wt.-%. No solvents (Z.2) are therefore solvents such as acetone, N-methyl-2-pyrrolidone, N-ethyl-2-pyrrolidone, tetrahydrofuran, dioxane, N-formylmorpholine, dimethylformamide or dimethyl sulfoxide.

The effect of selecting the specific solvents (Z.2) with only limited water solubility is in particular that on dispersing of the composition (Z) in aqueous phase, which takes place in step (II) of the process, a homogeneous solution cannot be formed directly, instead, the crosslinking reactions that take place within step (II) (addition reactions of free primary amino groups and isocyanate groups to form urea bonds) proceed in a limited volume, thereby enabling the formation of the microparticles as defined above.

The fraction of the at least one organic solvent (Z.2) is from 35 to 85 wt.-%, preferably from 40 to 75 wt.-%, more preferably from 45 to 70 wt.-%, especially preferably from 47.5 to 65 wt.-%, and, in one very particular embodiment, from 50 to 60 wt.-%, based in each case on the total amount of the composition (Z).

Within the present invention it has emerged that as a result of the targeted combination of an as-above-specified fraction of the intermediate (Z.1) in the composition (Z) and of the selection of the specific solvent (Z.2) it is possible in accordance with the steps (II) and (III) described below to provide polyurethane-polyurea dispersions which comprise polyurethane-polyurea particles (PPP) having the requisite particle size and gel fraction.

The components (Z.1) and (Z.2) described account in total for preferably at least 90 wt.-% of the composition (Z). The two components account for preferably at least 95 wt.-%, more particularly at least 97.5 wt.-%, of the composition (Z). With very particular preference the composition (Z) consists of these two components. In this context it may be noted that, where neutralizing agents as described above are employed, these neutralizing agents are included with the intermediate when calculating the amount of an intermediate (Z.1). The solids content of the composition (Z) preferably therefore corresponds to the fraction of the intermediate (Z.1) in the composition (Z). Accordingly, the composition (Z) preferably possesses a solids content of 15 to 65 wt.-%, preferably of 25 to 60 wt.-%, more preferably of 30 to 55 wt.-%, especially preferably of 35 to 52.5 wt.-%, and, in one very particular embodiment, from 40 to 50 wt.-%.

A particularly preferred composition (Z) therefore comprises in total at least 90 wt.-% of the components (Z.1) and (Z.2) and apart from the intermediate (Z.1) comprises exclusively organic solvents.

In step (II) of the process described here, then, the composition (Z) is dispersed in water, accompanied by deblocking of the blocked primary amino groups of the intermediate (Z.1) and by reaction of the resultant free primary amino groups with the isocyanate groups of the intermediate (Z.1) and also with the isocyanate groups of the deblocked intermediate resulting from the intermediate (Z.1), this reaction being an addition reaction.

Step (II) of the process of the invention may take place as described in WO 2018/011311 A1 and WO 2016/091546 A1.

The fraction of the polyurethane-polyurea particles (PPP) in the dispersion is preferably 25 to 55 wt.-%, preferably 30 to 50 wt.-%, more preferably 35 to 45 wt.-%, based in each case on the total amount of the dispersion (determined analogously to the determination via the solids content as described above for the intermediate (Z.1)).

The polyurethane-polyurea particles (PPP) preferably possess an acid number of 10 to 35 mg KOH/g, more particularly of 15 to 23 mg KOH/g (for measurement method, see Examples section). Moreover, the polyurethane-polyurea particles possess very few hydroxyl groups or none. The OH number of the particles is therefore less than 15 mg KOH/g, more particularly less than 10 mg KOH/g, more preferably less than 5 mg KOH/g (for measurement method, see Examples section).

The anionically stabilized polyurethane-polyurea particles (PPP) in dispersion in water preferably have, at a pH of 8.0, an electrophoretic mobility of −6 to −8 (μm/s)/(V/cm).

Furthermore, the coating composition may comprise the anionically stabilized polyurethane-polyurea particles (PPP) in a total amount of 10 to 50 wt.-%, preferably of 20 to 45 wt.-%, more particularly of 23 to 40 wt.-%, based in each case on the overall solids content of the coating composition. The use of the anionically stabilized polyurethane-polyurea particles (PPP) in the aforesaid total amounts, in combination with the at least one non-polymeric polycarboxylic acid, results in a high flop index. Moreover, the use of this binder leads to effective fixing of the oriented effect particles EP during the flashing of the coating composition of the invention, and so the high flop index is not negatively influenced even when further layers of coating composition are applied.

Other Anionically Stabilized Polymers (asP)

It may be advantageous in accordance with the invention, besides or instead of the above-described anionically stabilized polyurethane-polyurea particles (PPP), to use an anionically stabilized polymer (asP) as anionically stabilized polymeric binder.

With particular preference the composition of the invention comprises at least two mutually different anionically stabilized polymeric binders, with the first anionically stabilized polymeric binder being the aforesaid anionically stabilized polyurethane-polyurea particles (PPP), and the second anionically stabilized polymeric binder being the anionically stabilized polymer (asP) described below.

In the context of the present invention, it has therefore proven advantageous if the at least one anionically stabilized polymeric binder is an anionically stabilized seed-core-shell polymer (asP) in dispersion in water. It is therefore particularly preferred in accordance with the invention if the at least one anionically stabilized polymeric binder comprises at least one anionically stabilized polymer (asP) in dispersion in water and having an average particle size of 100 to 500 nm, the preparation of the anionically stabilized polymer (asP) comprising the consecutive radical emulsion polymerization of three mixtures (A), (B), and (C) of olefinically unsaturated monomers, where
the mixture (A) comprises at least 50 wt.-% of vinylaromatic monomers, and a polymer prepared from the mixture (A) possesses a glass transition temperature of 10 to 65 °C,
the mixture (B) comprises at least one polyunsaturated monomer, and a polymer prepared from the mixture (B) possesses a glass transition temperature of −35 to 15 °C, and
the mixture (C) comprises at least one anionic monomer, and a polymer prepared from the mixture (C) possesses a glass transition temperature of −50 to 15 °C,
and where
i. first the mixture (A) is polymerized,
ii. then the mixture (B) is polymerized in the presence of the polymer prepared under i., and
iii. thereafter the mixture (C) is polymerized in the presence of the polymer prepared under ii.

Glass transition temperature are determined as detailed in the Examples section.

The anionically stabilized polymer (asP) is in dispersion in water. Consequently, the anionically stabilized polymer (asP) takes the form of an aqueous dispersion. The expression “in dispersion in water or aqueous dispersion” is known in this context to the skilled person. It refers fundamentally to a system whose dispersion medium does not exclusively or primarily comprise organic solvents (also called solvents) but instead comprises a significant fraction of water. The aqueous dispersion preferably comprises a water fraction of 55 to 75 wt.-%, especially preferably 60 to 70 wt.-%, based in each case on the total weight of the dispersion.

There is preferably precisely one above-described polymer (asP) in dispersion in water. The preparation of the anionically stabilized polymer (asP) comprises the consecutive radical emulsion polymerization of three mixtures (A), (B) and (C) of olefinically unsaturated monomers, using water-soluble initiators, as described in WO 2017/088988 A1, for example.

The individual polymerization stages in the preparation of the anionically stabilized polymer (asP) may be carried out, for example, as what are called “starved feed” polymerizations (also known as “starve feed” or “starve fed” polymerizations). A starved feed polymerization in the sense of the present invention is an emulsion polymerization in which the amount of free olefinically unsaturated monomers in the reaction solution (also called reaction mixture) is minimized throughout the reaction time. This means that the metered addition of the olefinically unsaturated monomers is such that over the entire reaction time a fraction of free monomers in the reaction solution does not exceed 6.0 wt.-%, preferably 5.0 wt.-%, more preferably 4.0 wt.-%, particularly advantageously 3.5 wt.-%, based in each case on the total amount of the monomers used in the respective polymerization stage.

The concentration of the monomers in the reaction solution here may be determined by gas chromatography, for example, as described in laid-open specification WO 2017/088988 A1. The fraction of the free monomers can be controlled by the interplay of initiator quantity, rate of initiator addition, rate of monomer addition, and through the selection of the monomers. Not only the slowing-down of metering but also the increase in the initial quantity, and also the premature commencement of addition of the initiator, serve the aim of keeping the concentration of free monomers below the limits stated above.

For the purposes of the present invention, it is preferable for the polymerization stages ii. and iii. to be carried out under starved feed conditions. This has the advantage that the formation of new particle nuclei within these two polymerization stages is effectively minimized. Instead, the particles existing after stage i. (and therefore also called seed below) can be grown further in stage ii. by the polymerization of the monomer mixture B (therefore also called core below). It is likewise possible for the particles existing after stage ii. (also below called polymer comprising seed and core) to be grown further in stage iii. through the polymerization of the monomer mixture C (therefore also called shell below), resulting ultimately in a polymer comprising particles containing seed, core, and shell. Stage i. as well can of course be carried out under starved feed conditions.

The mixtures (A), (B), and (C) are mixtures of olefinically unsaturated monomers, and the mixtures (A), (B), and (C) are different from one another. They therefore each contain different monomers and/or different proportions of at least one defined monomer. The fractions of the monomer mixtures are preferably matched to one another as follows. The fraction of the mixture (A) is from 0.1 to 10 wt.-%, the fraction of the mixture (B) is from 60 to 80 wt.-% and the fraction of the mixture (C) is from 10 to 30 wt.-%, based in each case on the sum of the individual amounts of mixtures (A), (B), and (C).

Mixture (A) comprises at least 50 wt.-%, in particular at least 55 wt.-%, of vinylaromatic compounds. One such preferred monomer is styrene. Besides the vinylaromatic compounds, the mixture (A) contains no monomers that have functional groups containing heteroatoms. With particular preference, the monomer mixture (A) comprises at least one monounsaturated ester of (meth)acrylic acid with an alkyl radical and at least one monoolefinically unsaturated monomer containing vinyl groups, with a radical arranged on the vinyl group that is aromatic or that is a mixed saturated aliphatic-aromatic radical, in which case the aliphatic fractions of the radical are alkyl groups.

The monomers present in the mixture (A) are selected such that a polymer prepared from them possesses a glass transition temperature of 10 to 65 °C, preferably of 30 to 50 °C For a useful estimation of the glass transition temperature to be expected in the measurement, the Fox equation known to the skilled person can be employed.

The polymer prepared in stage i. by the emulsion polymerization of the monomer mixture (A) preferably has a particle size of 20 to 125 nm (for the measurement of the particle size see the Examples section).

Mixture (B) comprises at least one polyolefinically unsaturated monomer, preferably at least one diolefinically unsaturated monomer, in particular exclusively diolefinically unsaturated monomers. One such preferred monomer is 1,6-hexanediol diacrylate. Preferably the monomer mixture (B) likewise contains no monomers with functional groups containing heteroatoms. Particularly preferably, the monomer mixture (B), as well as at least one polyolefinically unsaturated monomer, includes at any rate the following further monomers. First of all, at least one monounsaturated ester of (meth)acrylic acid with an alkyl radical, and secondly at least one monoolefinically unsaturated monomer containing vinyl groups and having a radical arranged on the vinyl group that is aromatic or that is a mixed saturated aliphatic-aromatic radical, in which case the aliphatic fractions of the radical are alkyl groups.

The fraction of polyunsaturated monomers is preferably from 0.05 to 3 mol %, based on the total molar amount of monomers in the monomer mixture (B).

The monomer mixtures (A) and (B) preferably contain no hydroxy-functional monomers and no acid-functional monomers. The monomer mixtures (A) and (B) accordingly contain 0 wt.-%, based on the sum of the individual amounts of the mixtures (A), (B) and (C), of hydroxy-functional and acid-functional monomers.

The monomers present in the mixture (B) are selected such that a polymer prepared therefrom possesses a glass transition temperature of −35 to 15 °C, preferably of −25 to +7 °C.

The polymer which is obtained after stage ii. preferably possesses a particle size of 80 to 280 nm, preferably 120 to 250 nm.

The monomers present in the mixture (C) are selected such that a polymer prepared therefrom possesses a glass transition temperature of −50 to 15 °C, preferably of −20 to +12 °C.

The olefinically unsaturated monomers of this mixture (C) are preferably selected such that the resulting polymer, comprising seed, core, and shell, has an acid number of 10 to 25. Accordingly, the mixture (C) preferably comprises at least one α,β-unsaturated carboxylic acid, especially (meth)acrylic acid.

The olefinically unsaturated monomers of the mixture (C) are further preferably selected such that the resulting polymer, comprising seed, core, and shell, has an OH number of 0 to 30, preferably 10 to 25. All of the aforementioned acid numbers and OH numbers are values calculated on the basis of the monomer mixtures employed overall.

Particularly preferably, the monomer mixture (C) comprises at least one α,β-unsaturated carboxylic acid, at least one monounsaturated ester of (meth)acrylic acid having an alkyl radical substituted by a hydroxyl group, and at least one monounsaturated ester of (meth)acrylic acid having an alkyl radical.

With particular preference neither the monomer mixture (A) nor the monomer mixtures (B) or (C) comprise a polyurethane polymer which has at least one polymerizable double bond.

Following its preparation, the anionically stabilized polymer (asP) possesses an average particle size of 100 to 500 nm, preferably 125 to 400 nm, very preferably from 130 to 300 nm, and also a glass transition temperature T_{g} of −20 to −5 °C The aqueous dispersion of the anionically stabilized polymer (asP) preferably possesses a pH of 5.0 to 9.0, more preferably 7.0 to 8.5, very preferably 7.5 to 8.5.

The pH may be kept constant during the preparation itself, through the use of bases as identified further on below, for example, or else may be set deliberately after the anionically stabilized polymer (asP) has been prepared. The stages i. to iii. described are carried out preferably without addition of acids or bases known for the setting of the pH, and the pH is set only after the preparation of the polymer, by addition of organic, nitrogen-containing bases, sodium hydrogencarbonate, borates, and also mixtures of the aforesaid substances.

The solids content of the aqueous dispersion of the anionically stabilized polymer (asP) is preferably from 15% to 40% and more preferably 20% to 30%.

An anionically stabilized polymer (asP) used particularly in the context of the present invention is preparable by reacting
a mixture (A) of 50 to 85 wt.-% of a vinylaromatic monomer and 15 to 50 wt.-% of a monounsaturated ester of (meth)acrylic acid with an alkyl radical,
a mixture (B) of 1 to 4 wt.-% of a polyolefinically unsaturated monomer, 60 to 80 wt.-% of a monounsaturated ester of (meth)acrylic acid with an alkyl radical, and 16 to 39 wt.-% of a vinylaromatic monomer, and
a mixture (C) of 8 to 15 wt.-% of an alpha-beta unsaturated carboxylic acid, 10 to 20 wt.-% of a monounsaturated ester of (meth)acrylic acid with an alkyl radical substituted by a hydroxyl group, and 65 to 82 wt.-% of monounsaturated esters of (meth)acrylic acid with an alkyl radical, where
i. first the mixture (A) is polymerized,
ii. then the mixture (B) is polymerized in the presence of the polymer prepared under i., and
iii. thereafter the mixture (C) is polymerized in the presence of the polymer prepared under ii.
The above figures in wt.-% are based in each case on the total weight of the mixture (A) or (B) or (C), respectively.

The anionically stabilized polymer (asP) in dispersion in water, in other words the aqueous dispersion of this polymer (asP), advantageously has a defined electrophoretic mobility. It is therefore preferred in accordance with the invention if the anionically stabilized polymer (asP) in dispersion in water has at a pH of 8.0 an electrophoretic mobility of −2.5 to −4 (μm/s)/(V/cm).

Moreover, the coating composition may comprise the anionically stabilized polymer (asP) in a total amount of 1 to 30 wt.-%, preferably of 5 to 20 wt.-%, more particularly of 5 to 10 wt.-%, based in each case on the overall solids content of the coating composition. The use of the anionically stabilized polymer (asP) in the aforesaid total amounts, in combination with the at least one non-polymeric polycarboxylic acid, leads to a high flop index. Moreover, the use of this binder leads to effective fixing of the oriented effect particles EP during the flashing of the coating composition of the invention, so that the high flop index is not adversely affected even on application of further layers of coating composition.

The coating composition of the invention, as anionically stabilized polymeric binder, may comprise at least one above-described anionically stabilized polymer (asP) or the above-described anionically stabilized polyurethane-polyurea particles (PPP). Preferably the coating composition comprises as anionically stabilized polymeric binder at least one above-described anionically stabilized polymer (asP) and also the above-described anionically stabilized polyurethane-polyurea particles (PPP). With particular preference these polymers are present in a certain weight ratio in the composition. It is therefore advantageous in accordance with the invention if the aqueous coating composition has a weight ratio of the anionically stabilized polymer (asP) to the anionically stabilized polyurethane-polyurea particles (PPP) of 1:10 to 1:1, more particularly of 1:6 to 1:4.

### Further Polymeric Binders

The coating composition of the invention, besides the at least one anionically stabilized polymeric binder, may comprise at least one further binder, more particularly at least one polymer selected from the group consisting of polyurethanes, polyesters, polyacrylates and/or copolymers of the stated polymers, more particularly polyesters and/or polyurethane polyacrylates.

This further binder is different from the anionically stabilized polymeric binders (PPP) and (asP). Preferred polyesters are described, for example, in DE 4009858 A1 in column 6, line 53 to column 7, line 61 and column 10, line 24 to column 13, line 3, and in WO 2014/033135 A1 at page 28, lines 13 to 33. The described polymers as binders are preferably hydroxy-functional and especially preferably possess an OH number in the range from 20 to 200 mg KOH/g, more preferably from 50 to 150 mg KOH/g. Used more preferably are at least two mutually different hydroxy-functional polyesters as further binder.

The total amount of all polymeric binders based on the total weight of the aqueous coating material of the invention, is preferably from 9 to 60 wt.-%, more preferred from 20 to 50 wt.-% a and most preferred from 30 to 45 wt.-%.

### Cellulose Nanofibers

The term “cellulose nanofibers” may also be referred to as “cellulose nanofibrils,” “fibrillated cellulose,” or “nanocellulose crystals” in the literature; all of which are fiber-shaped. The term is “cellulose nanofibers” is a generic term encompassing natural as well as functionalized cellulose nanofibers, such as carboxylated or sulfated or otherwise modified and/or surface functionalized cellulose nanofibers. However, the backbone carrying such groups is always cellulose.

Of course, cellulose derivatives which are not fiber-shaped do not fall under the term “cellulose nanofibers”. Particularly, hydroxyalkyl celluloses, which are, e.g., dissolved in aqueous media, are not encompassed by the term “cellulose nanofibers” as used herein. As those water compatible cellulose types are completely dissolved in water, they do exhibit different (molecular) dimensions and consequently do show a complete different rheological behavior, suitable for wallpaper pastes, etc. (A. Goldschmidt, H. J. Streitberger, BASF Handbook on Basics of Coatings Technology, 2003, Vincentz Network, page 47-49).

The cellulose nanofibers preferably have a numerical average fiber diameter within the range of preferably 2 to 800 nm, more preferably 2 to 500 nm, even more preferably 2 to 250 nm, and most preferably 2 to 150 nm.

The cellulose nanofibers preferably have a numerical average fiber length within the range of preferably 0.04 to 20 μm, more preferably 0.04 to 15 μm, even more preferably 0.04 to 10 μm.

The aspect ratio determined by dividing the numerical average fiber length by the numerical average fiber diameter is preferably within the range of preferably 20 to 10000, more preferably 20 to 5000, and even more preferably 20 to 1000.

The numerical average values of fiber length, diameter and aspect ratio of the cellulose nanofibers are determined as specified in the experimental part of the present invention.

The cellulose nanofibers for use may be those obtained by defibrating a cellulose material and stabilizing it in water. The cellulose material as used here refers to cellulose-main materials in various forms. Specific examples include pulp (e.g., grass plant-derived pulp, such as wood pulp, jute, Manila hemp, and kenaf); natural cellulose, such as cellulose produced by microorganisms; regenerated cellulose obtained by dissolving cellulose in a copper ammonia solution, a solvent of a morpholine derivative, or the like, and subjecting the dissolved cellulose to spinning; and fine cellulose obtained by subjecting the cellulose material to mechanical treatment, such as hydrolysis, alkali hydrolysis, enzymatic decomposition, blasting treatment, vibration ball milling, and the like, to depolymerize the cellulose.

The method for defibrating the cellulose material is not particularly limited, as long as the cellulose material remains in a fibrous form. Examples of the method include mechanical defibration treatment using a homogenizer, a grinder, and the like; chemical treatment using an oxidation catalyst and the like; and biological treatment using microorganisms and the like.

For the cellulose nanofibers, anionically modified cellulose nanofibers may be used and are preferably used. Examples of anionically modified cellulose nanofibers include carboxylated cellulose nanofibers, carboxymethylated cellulose nanofibers, sulfated cellulose nanofibers and the like. The anionically modified cellulose nanofibers can be obtained, for example, by incorporating functional groups such as carboxyl groups and carboxymethyl groups into a cellulose material by a known method, washing the obtained modified cellulose to prepare a dispersion of the modified cellulose, and defibrating this dispersion. The carboxylated cellulose is also referred to as “oxidized cellulose.”

The oxidized cellulose is obtained, for example, by oxidizing the cellulose material in water using an oxidizing agent in the presence of a compound selected from the group consisting of N-oxyl compounds, bromide, iodide, and mixtures thereof.

The amount of an N-oxyl compound is not particularly limited, as long as the amount is a catalytic amount that can disintegrate cellulose into nanofibers.

The amount of bromide or iodide can be suitably selected within the range in which an oxidation reaction is promoted.

For the oxidizing agent, a known oxidizing agent may be used. Examples include halogen, hypohalous acid, halous acid, perhalogenic acid, salts thereof, halogen oxide, peroxide, and the like. It is preferable to set conditions so that the amount of carboxyl groups in oxidized cellulose is 0.2 mmol/g or more based on the solids content mass of the oxidized cellulose. The amount of carboxyl groups can be adjusted, for example, by performing the following: adjustment of oxidation reaction time; adjustment of oxidation reaction temperature; adjustment of pH in oxidation reaction; and adjustment of the amount of an N-oxyl compound, bromide, iodide, oxidizing agent, or the like.

The carboxymethylated cellulose may be obtained by mixing a cellulose material and a solvent, performing a mercerization treatment using 0.5 to 20-fold moles of alkali hydroxide metal per glucose residue of the cellulose material as a mercerization agent at a reaction temperature of 0 to 70 °C for a reaction time of about 15 minutes to 8 hours, and then adding thereto 0.05 to 10.0-fold moles of a carboxy-methylating agent per glucose residue, followed by reaction at a reaction temperature of 30 to 90 °C for a reaction time of about 30 minutes to 10 hours.

The degree of substitution of carboxy methyl per glucose unit in the modified cellulose obtained by introducing carboxymethyl groups into the cellulose material is preferably 0.02 to 0.50.

The thus-obtained anionically modified cellulose can be dispersed in an aqueous solvent to form a dispersion and then defibrated with a disintegrator. The defibration method is not particularly limited. When mechanical defibration is performed, the disintegrator for use may be any of the following: a high-speed shearing disintegrator, a collider disintegrator, a bead mill disintegrator, a high-speed rotating disintegrator, a colloid mill disintegrator, a high-pressure disintegrator, a roll mill disintegrator, and an ultrasonic disintegrator. These disintegrators may be used in a combination of two or more.

Further, cellulose obtained by neutralizing the above oxidized cellulose with a basic neutralizer can also be suitably used as the cellulose-based rheology control agent. Neutralization using such a neutralizer improves the antiwater adhesion of rheology control agents, including cellulose nanofibers. The neutralizer for the oxidized cellulose in the present specification is a neutralizer of an organic base bulkier than inorganic metal salt groups, such as sodium hydroxide. Preferable examples of the neutralizer include organic bases, such as quaternary ammonium salts and amines (primary amine, secondary amine, and tertiary amine). Preferable quaternary ammonium salts are quaternary ammonium hydroxide. Examples of amines include alkylamines and alcoholamines. Examples of alkylamines include N-butylamine, N-octylamine, dibutylamine, triethylamine, and the like. Examples of alcoholamines include N-butyl ethanolamine, N-methyl ethanolamine, 2-amino-2-methyl-1-propanol, dimethyl ethanolamine, dibutyl ethanolamine, methyl diethanolamine, and the like.

The content of the neutralizer is not particularly limited, as long as a part or whole of the oxidized cellulose can be neutralized. However, the content of the neutralizer is preferably 0.2 to 1.0 equivalent, in terms of neutralization equivalent based on the contained acid group.

The content of the cellulose nanofibers based on the total weight of the aqueous coating material of the present invention, is preferably in the range from 0.05 to 1.5 wt.-%, more preferred from 0.06 to 1.0 wt.-% and most preferred from 0.07 to 0.7 wt.-%.

Examples of commercial products of the cellulose nanofibers include Rheocrysta (registered trademark, produced by Dai-Ichi Kogyo Seiyaku Co., Ltd.); Cebina Fine (length 0.5 to 10 μm, diameter 15 to 100 nm), Celluforce NCV100 (length 44 to 108 nm, diameter 2.3 to 4.5 nm).

### Non-Polymeric Polycarboxylic Acids

The aqueous coating materials of the present invention contain at least one non-polymeric polycarboxylic acid or salt thereof, preferably at least one monomeric polycarboxylic acid or salt thereof, even more preferred at least one monomeric dicarboxylic acid or salt thereof.

The term “polycarboxylic acid” refers in accordance with the invention to aliphatic or aromatic carboxylic acids which have at least two carboxylic acid groups per molecule, such as 2 to 4, more preferably 2 or 3 and most preferably 2 carboxylic acid groups. These carboxylic acid groups may be converted wholly or partly by neutralizing agents into anionic groups.

The at least one non-polymeric polycarboxylic acid preferably has a melting point of 80 to 165 °C, more preferably of 85 to 150 °C, preferably of 90 to 140 °C, more particularly of 95 to 120 °C.

The at least one non-polymeric polycarboxylic acid is most preferably a dicarboxylic acid. Dicarboxylic acids in accordance with the invention are compounds which have precisely two carboxylic acid groups per molecule.

In this context it is especially preferred if the dicarboxylic acid has the general formula (I)

M⁺⁻OOC—R¹—COO⁻M⁺ (I)

in which
both M⁺ are independently of each other monovalent cations, preferably selected from the group consisting of H⁺, an alkali metal cation such as Na⁺, K⁺, an ammonium ion NH₄⁺, and a cation of formula N(R²)₄⁺ wherein residues R² are independently of each other are H, alkyl residues and hydroxyalkyl residues, the alkyl residues preferably comprising 1 to 6, more preferred 1 to 4, even more preferred 1 to 3 and most preferred 1 or 2, particularly 1 carbon atom and the hydroxyalkyl residues preferably comprising 2 to 6, more preferred 2 to 4, even more preferred 2 to 3 and most preferred 2 carbon atoms; and
R¹ being not present (i.e., M⁺⁻OOC—COO⁻M⁺) or being a divalent residue of a saturated or unsaturated, aliphatic or aromatic, linear, branched or cyclic hydrocarbon, residue R¹ preferably comprising 1 to 72, preferably from 2 to 40, more preferably from 3 to 30, even more preferably from 3 to 18, more particularly 4 to 9, such as 4, 5, 6, 7 or 8 carbon atoms.

In case R¹ contains more than 20, or even more than 30 carbon atoms, residue R¹ is preferably the residue of a dimer fatty acid, dimers and trimer are herein not considered polymeric. Such groups optionally and preferably comprise one or more carbon-carbon double bonds and/or cyclic, particularly cycloaliphatic hydrocarbon groups.

Preferred monovalent cations M⁺ are, e.g., cations of formula (CH₃)₂(alkyl-OH)NH⁺, such as the protonated dimethylethanol amine.

The use of the above-recited dicarboxylic acids, especially of azelaic acid, has proven to be particularly advantageous, in combination with the other mandatory ingredients and in case effect pigments are contained in the aqueous coating material for the attainment of a high flop index, but without leading to reduced storage stability on the part of the aqueous coating material or an adverse influence on the optical and coloristic properties of the coatings produced from these compositions.

Polycarboxylic acids as used in accordance with the invention are available commercially, for example, from Merck.

The at least one non-polymeric polycarboxylic acid is preferably used in a particular total amount. It is therefore particularly preferred in accordance with the invention if the aqueous coating material comprises the at least one non-polymeric polycarboxylic acid, more particularly the dicarboxylic acid in formula (I) in a total amount of 0.05 to 5 wt.-%, preferably of 0.10 to 4 wt.-%, more preferably of 0.20 to 3 wt.-%, more particularly of 0.25 to 1 wt.-%, based in each case on the total weight of the coating material.

### Pigments

Preferably the aqueous coating material of the present invention further comprise one or more pigments selected from the group consisting of color pigments and effect pigments.

### Color Pigments

Color pigments are known to those skilled in the art and are described, for example, in Rompp-Lexikon Lacke and Druckfarben, Georg Thieme Verlag, Stuttgart, New York, 1998, pages 176 and 451. The terms “coloring pigment” and “color pigment” are interchangeable.

Suitable color pigments can be inorganic or organic pigments and are preferably selected from the group consisting of (i) white pigments such as titanium dioxide, zinc white, zinc sulfide or lithopone; (ii) black pigments such as carbon black, iron manganese black, or spinel black; (iii) chromatic pigments such as ultramarine green, ultramarine blue, manganese blue, ultramarine violet, manganese violet, red iron oxide, molybdate red, ultramarine red, brown iron oxide, mixed brown, spinel phases and corundum phases, yellow iron oxide, bismuth vanadate; (iv) organic pigments such as monoazo pigments, bisazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, prinone pigments, perylene pigments, phthalocyanine pigments, aniline black; and (v) mixtures thereof.

The one or more color pigments are used preferably in a particular total amount. In preferred embodiments of the first subject-matter of the invention, therefore, the aqueous coating composition preferably comprises the color pigment(s) CP in a total amount of 1 to 40 wt. %, preferably of 2 to 35 wt. %, more preferably of 5 to 30 wt. %, based in each case on the total weight of the coating composition.

### Effect Pigments EP

The one or more effect pigments EP are preferably selected from the group of lamellar aluminum pigments, aluminum pigments of “cornflake” and/or “silver dollar” form, aluminum pigments coated with organic pigments (available commercially under the brand name “Friend Color®” from Toyal, for example), glass flakes (available commercially under the brand name “Luxan®)” from Eckart, for example), glass flakes coated with interference layers, gold bronzes, oxidized bronzes, iron oxide-aluminum pigments, pearlescent pigments, metal oxide-mica pigments, lamellar graphite, platelet-shaped iron oxide, multilayer effect pigments composed of PVD films, and mixtures thereof, more particularly lamellar aluminum pigments.

In this context it has proven particularly advantageous if passivated lamellar aluminum pigments are used. An assurance may thus be given of high storage stability on the part of the aqueous coating materials of the invention. Preferably, therefore, the lamellar aluminum pigments are treated with a passivating agent, the passivating agent being selected from the group of silanes, organic polymers, chromium compounds, phosphoric acid derivatives, molybdenum derivatives, and mixtures thereof, especially chromium compounds. Derivatives in this context are compounds in which an H atom or a functional group has been replaced by another atom or another group of atoms, and/or in which one or more atoms/groups of atoms have been removed.

Moreover, it has proven advantageous in this context if the lamellar aluminum pigments have a defined platelet thickness and average particle size. The lamellar aluminum pigments preferably have a platelet thickness of 200 to 500 nm and an average particle size D₅₀ of 10 to 25 μm, more particularly 10 to 20 μm (for measurement method, see Examples section).

The one or more effect pigment are used preferably in a particular total amount. Preferably the aqueous coating material comprises the at least one effect pigment EP, more particularly lamellar aluminum pigments, in a total amount of 1 to 20 wt.-%, preferably of 2 to 15 wt.-%, more preferably of 2.5 to 10 wt.-%, more particularly of 3 to 7 wt.-%, based in each case on the total weight of the coating material. The use of the effect pigments, especially of the above-described lamellar aluminum pigments, in the stated total amounts, in combination with the at least one polymeric binder, preferably at the least one anionically stabilized polymeric binder and also the at least one non-polymeric polycarboxylic acid and the at least one cellulose nanofiber material, leads to a particularly high flop index, though without detriment to the other optical and coloristic properties of the coating.

### Fillers

The aqueous coating materials of the present invention preferably contain one or more fillers. The difference between fillers and pigments in the present invention is not crucial. To distinguish both, it is typically referred to the refractive index. If the refractive index is ≥1.7 the substance is considered to be a pigment and if the refractive index is <1.7 the substance is considered to be a filler. Fillers are preferably selected from the group of carbonates, silicates such as talc, silicas such as precipitated or fumed silica, and sulfates such as barium sulfate.

### Further Constituents

The aqueous coating material of the invention, besides the above-recited mandatory polymeric binder PB, cellulose nanofibers CF and non-polymeric polycarboxylic acid, may also comprise one or more further constituents, such as neutralizing agents, thickeners, crosslinking agents, and solvents but also other additives such as levelling agents, dispersion agents, wetting agents, defoamers or catalysts.

### Neutralizing Agents

The neutralizing agent is preferably selected from the group of inorganic bases, primary amines, secondary amines, tertiary amines, and mixtures thereof, especially dimethylethanolamine. The neutralizing agent, especially dimethylethanolamine, is used with particular preference for neutralizing the at least one non-polymeric polycarboxylic acid. In this way the solubility of the non-polymeric polycarboxylic acid in the aqueous coating material can be increased.

It is preferred in this context if the at least one neutralizing agent, especially dimethylethanolamine, is present in a total amount of 0.25 to 5 wt.-%, preferably of 0.3 to 4 wt.-%, more preferably of 0.5 to 3 wt.-%, more particularly of 1 to 3 wt.-%, based in each case on the total weight of the coating material. The use of the neutralizing agent, especially dimethylethanolamine, in the quantity ranges recited above, in combination with the at least one solvent L, ensures sufficient solubilization of the non-polymeric polycarboxylic acid and hence provides an assurance of homogeneous incorporation and also high storage stability on the part of the coating materials of the invention.

### Thickeners

The thickener is preferably selected from the group of phyllosilicates, (meth)acrylic acid-(meth)acrylate copolymers, hydrophobically modified ethoxylated polyurethanes, hydrophobically modified polyethers, non-fiber-shaped hydroxyalkylcelluloses, polyamides, and mixtures thereof, especially (meth)acrylic acid-(meth)acrylate copolymers and/or hydrophobically modified ethoxylated polyurethanes. (Meth)acrylic acid-(meth)acrylate copolymers are obtainable by reaction of (meth)acrylic acid with (meth)acrylic esters. Depending on the length of the carbon chain in the (meth)acrylic esters, these copolymers have an associative thickening effect (ASE or HASE thickeners). Copolymers containing exclusively C₁-C₄ alkyl(meth)acrylates do not have an associative thickening effect (ASE thickeners). Conversely, copolymers which contain (meth)acrylates having a chain length of more than four carbon atoms do possess an associative thickening effect (HASE thickeners). Hydrophobically modified ethoxylated polyurethanes are obtainable by reaction of a diisocyanate with a polyether and subsequent reaction of this prepolymer with a hydrophobic alcohol. Such polyurethanes are also referred to as HEUR thickeners. Particularly preferred is the use of a combination of non-associative thickening (meth)acrylic acid-(meth)acrylate copolymers and hydrophobically modified ethoxylated polyurethanes.

It is preferred in this context if the at least one thickener, more particularly (meth)acrylic acid-(meth)acrylate copolymers and/or hydrophobically modified ethoxylated polyurethanes, is present in a total amount of 0.015 to 3 wt.-%, preferably of 0.03 to 2 wt.-%, more preferably of 0.04 to 1 wt.-%, more particularly of 0.05 to 0.7 wt.-%, based in each case on the total weight of the coating material.

According to one particularly preferred embodiment of the present invention, the aqueous coating material comprises no phyllosilicates and/or polyamides, more particularly no phyllosilicates and no polyamides. This means that the phyllosilicates and/or polyamides, more particularly phyllosilicates and polyamides, are present in a total amount of 0 wt.-%, based on the total weight of the coating material. Surprisingly, the use of a non-polymeric polycarboxylic acid without additional use of polyamides and/or phyllosilicates leads to a flop index which is comparable with the use of polyamides and/or phyllosilicates. When the at least one non-polymeric polycarboxylic acid is used, however, there are no unwanted separation phenomena and no reduced shear stability.

### Crosslinking Agents

In case the mandatory polymeric binder is a thermochemically curable binder a crosslinking agent is typically present. The crosslinking agent is preferably selected from the group of melamine-formaldehyde resins, polyisocyanates, blocked polyisocyanates, polycarbodiimides and mixtures thereof, especially melamine-formaldehyde resins.

It is preferred in this context if the at least one crosslinking agent, especially melamine-formaldehyde resin, is present in a total amount of 1 to 10 wt.-%, preferably of 2 to 6 wt.-%, more preferably of 3 to 5 wt.-%, more particularly of 4 to 6 wt.-%, based in each case on the total weight of the coating material. The aforesaid total quantities ensure sufficient crosslinking of the aqueous coating material.

### Organic Solvents

As further constituent of the aqueous coating material of the invention one or more organic solvents can be comprised in the coating material. Such solvents may particularly serve, besides the mandatory water, to solubilize the one or more non-polymeric polycarboxylic acid and so permits homogeneous incorporation of those.

The at organic solvent is preferably selected from alkoxy-C₂-C₁₀ alcohols, ketones, esters, amides, methylal, butylal, 1,3-dioxolane, glycerol formal and mixtures thereof, especially 1-methoxy-2-propanol.

The combined amount of water and one or more organic solvents is preferably in the range from 0.3 to 30 wt.-%, preferably of 1.5 to 30 wt.-%, more preferably from 3 to 18 wt.-%, more particularly of 6 to 18 wt.-%, based in each case on the total weight of the coating material. The use of the aforesaid amounts of the at least one organic solvent and/or water, may lead to an increased solubilization of the at least one non-polymeric polycarboxylic acid in the aqueous coating material.

### Method for Producing a Multicoat Paint System

The invention also provides a method for producing a multicoat paint system on a substrate, the method comprising the following steps:
(1) optionally producing a cured first coating layer on the substrate by application of a coating material to the substrate and subsequent curing of the composition;
(2) producing one or more basecoat layers on the coating layer obtained in step (1) by application of one or more identical or different aqueous basecoat material;
(3) producing one or more clearcoat layers one the one or the topmost basecoat layer by application of a clearcoat material; and
(4) jointly curing the one or more basecoat layers and the one or more clearcoat layers;
wherein
   at least one of the basecoat materials is a pigmented aqueous coating material according to the invention.

In the method of the invention, a multicoat paint system is built up on a substrate.

With preference in accordance with the invention, the substrate is selected from metallic substrates, plastics, glass and ceramics, more particularly from metallic substrates.

Metallic substrates contemplated essentially include substrates comprising or consisting of, for example, iron, aluminum, copper, zinc, magnesium, and alloys thereof, and also steel, in any of a very wide variety of forms and compositions. Preferred substrates are those of iron and steel, especially being typical iron and steel substrates as used in the automotive industry sector. Before step (1) of the method of the invention, the metallic substrates may be pretreated in a conventional way—that is, for example, cleaned and/or provided with known conversion coatings.

Suitable plastics substrates are in principle substrates comprising or consisting of (i) polar plastics, such as polycarbonate, polyamide, polystyrene, styrene copolymers, polyesters, polyphenylene oxides, and blends of these plastics, (ii) reactive plastics, such as PUR-RIM, SMC, BMC, and also (iii) polyolefin substrates of the polyethylene and polypropylene types with a high rubber content, such as PP-EPDM, and also surface-activated polyolefin substrates. The plastics may also be fiber-reinforced, more particularly using carbon fibers and/or metal fibers. Substrates of plastic as well may be pretreated, more particularly by cleaning, before step (1) of the method of the invention, in order to improve the adhesion of the first coating layer.

As substrates it is also possible, moreover, to use those which contain both metallic and plastics fractions. Substrates of this kind are, for example, vehicle bodies containing plastics parts.

### Step (1)

In step (1) of the method of the invention, a cured first coating layer may be produced on the substrate by application of a coating material to the substrate (S) and optional subsequent curing.

The coating material of step (1) may be an electrocoat coating material and may also be a primer coating material. A primer coating material in accordance with the invention, however, is not the basecoat applied in step (2) of the method of the invention.

The method of the invention is preferably carried out with metallic substrates. The first coating layer, therefore, is preferably a cured electrocoat layer. In one preferred embodiment of the method of the invention, accordingly, the coating material is an electrocoat coating material which is applied by electrodeposition coating to the substrate. Suitable electrocoat coating materials and also their curing are described in WO 2017/088988 A1, for example.

### Step (2)

In step (2) of the method of the invention, one basecoat layer is produced (Alternative 1), or two or more directly consecutive basecoat layers are produced (Alternative 2).

The layers are produced by application of an aqueous basecoat material directly to the substrate (S) or directly to the cured coating layer obtained in step (1) or by directly consecutive application of two or more basecoat materials to the substrate or to the cured coating layer obtained in step (1).

After having been produced, therefore, the basecoat layer according to Alternative 1 of step (2) is disposed directly on the substrate or directly on the cured coating layer obtained in step (1).

The directly consecutive application of two or more basecoat materials to the cured coating layer obtained in step (1) (Alternative 2) is understood as follows:

The application of the first basecoat material produces a first basecoat layer directly on the cured first coat of step (1). The at least one further basecoat layer is then produced directly on the first basecoat layer. Where two or more further basecoat layers are produced, they are produced directly consecutively. For example, precisely one further basecoat layer can be produced, which in that case, in the multicoat paint system ultimately produced, is disposed directly below the first or only clearcoat layer. If two or more basecoat layers are applied, it may be preferable for the first basecoat layer produced directly on the substrate or directly on the cured first coat to be based on a color-preparatory basecoat material. The second and the optional third layer are based either on the same color- and/or effect-imparting basecoat material, or on a first color- and/or effect-imparting basecoat material and on a different, second color- and/or effect-imparting basecoat material.

The basecoat materials may be identical or different. It is also possible to produce two or more basecoat layers with the same basecoat material, and one or more further basecoat layers with one or more other basecoat materials. At least one of the aqueous basecoat materials used in step (2), however, comprises the pigmented aqueous coating material of the invention.

Embodiments preferred in the context of the present invention encompass, according to Alternative 1 of step (2) of the method of the invention, the production of a basecoat layer.

The basecoat layers are cured not separately but rather together with the clearcoat material. In particular, the coating materials as used in step (2) of the method of the invention are not cured separately like the coating materials referred to as surfacers in the context of the standard method. The basecoat layers are therefore preferably not exposed to temperatures of above 100 °C for a time of longer than 1 minute, and with particular preference are not exposed at all to temperatures of more than 100 °C in step (2).

The basecoat materials are applied such that, after the curing in step (4), the basecoat layer and the individual basecoat layers each have a layer thickness of, for example, 5 to 50 micrometers, preferably 6 to 40 micrometers, especially preferably 7 to 35 micrometers. In the first alternative of step (2), preference is given to producing basecoat layers having relatively high layer thicknesses of 15 to 50 micrometers, preferably 20 to 45 micrometers. In the second alternative of step (2), the individual basecoat layers tend to have layer thicknesses which are lower by comparison, with the overall system then again having layer thicknesses which lie within the order of magnitude if just one basecoat layer is produced. In the case of two basecoat layers, for example, the first basecoat layer preferably has layer thicknesses of 5 to 35 micrometers, more particularly 10 to 30 micrometers, the second basecoat layer preferably has layer thicknesses of 5 to 35 micrometers, more particularly 10 to 30 micrometers, and the overall layer thickness does preferably not exceed 50 micrometers.

### Step (3)

In step (3) of the method of the invention, a clearcoat layer is produced directly on the one basecoat layer or on the topmost basecoat layer. This production is accomplished by corresponding application of a clearcoat material. Suitable clearcoat materials are described for example in WO 2006042585 A1, WO 2009077182 A1 or else WO 2008074490 A1.

The clearcoat material or the corresponding clearcoat layer, following application, is flashed and/or interim-dried preferably at 15 to 35 °C for a time of 0.5 to 30 minutes.

The clearcoat material is applied in such a way that the layer thickness of the clearcoat layer after the curing in step (4) is from, for example, 15 to 80 micrometers, preferably 20 to 65 micrometers, especially preferably 25 to 60 micrometers.

### Step (4)

In step (4) of the method of the invention, there is joint curing of the basecoat layer and of the clearcoat layer, or of the basecoat layers and of the clearcoat layer.

The joint curing takes place preferably at temperatures of 100 to 250 °C, preferably 100 to 180 °C, for a duration of 5 to 60 minutes, preferably 10 to 45 minutes.

The method of the invention allows the production of multicoat paint systems on substrates without a separate curing step.

In respect of further preferred embodiments of the method of the invention, especially in respect of the basecoat materials used therein and of the components of these basecoat materials, the statements made in relation to the coating material of the invention are valid mutatis mutandis.

### Multicoat Paint System

After the end of step (4) of the method of the invention, the result is a multicoat paint system of the invention.

With particular preference the surface of this multicoat paint system, has a flop index of 8 to 30, preferably of 10 to 30, more particularly of 12.5 to 30. This high flop index is achieved by using the pigmented aqueous coating materials of the present invention, despite the preferred absence of polyamides and/or layered metal silicates. The flop index achieved with the composition of the invention is comparable in this context with that of compositions which do include polyamides and/or phyllosilicates.

In respect of further preferred embodiments of the multicoat paint system of the invention, the comments made regarding the coating composition of the invention and also regarding the method of the invention are valid mutatis mutandis.

### Inventive Uses

A further subject of the present invention is the use of a non-pigmented aqueous coating material according to the present invention as universal aqueous coating composition for the production of the pigmented aqueous coating material of the present invention.

Yet another subject of the present invention is the use of at least one type of cellulose nanofibers as defined above together with one or more non-polymeric polycarboxylic acids and/or their salts as defined above in an aqueous coating material comprising one or more polymeric binders as defined above and one or more pigments as defined above, in the production of a multilayer coating system.

Further subject of the present invention is the use of the pigmented aqueous coating materials of the present invention as basecoat materials.

The afore-mentioned uses are particularly for improving the flop index and color matching compared to multilayer coating systems comprising pigmented aqueous basecoat layers which do not comprise polyamides and/or layered metal silicates.

The subsequent color matching obviates the need for disposal of aqueous coating compositions which directly after production or because of storage are outside specification and would therefore have to be disposed of. This results in an improved environmental balance and efficiency of basecoat production and also of the production of paint systems using these coating compositions.

In respect of further preferred embodiments of the inventive uses, the comments made in relation to the coating material of the invention, to the method of the invention, and to the multicoat paint system of the invention are valid mutatis mutandis.

### EXPERIMENTAL SECTION/EXAMPLES SECTION

### Description of Methods

### Solids Content (Solids, Nonvolatile Fraction)

The nonvolatile fraction is determined according to DIN EN ISO 3251 (date: June 2008). It involves weighing out 1 g of sample into an aluminum dish which has been dried beforehand, drying it in a drying oven at 125 °C for 60 minutes, cooling it in a desiccator and then reweighing it. The residue relative to the total amount of sample used corresponds to the nonvolatile fraction. The volume of the nonvolatile fraction may optionally be determined, if necessary, according to DIN 53219 (date: August 2009).

### Glass Transition Temperature T_{g}

The glass transition temperature T_{g} for the purposes of the invention is determined experimentally on the basis of DIN 51005 “Thermal Analysis (TA)—Terms” and DIN 53765 “Thermal Analysis Dynamic Scanning calorimetry (DSC)”. This involves weighing out a 15 mg sample into a sample boat and introducing it into a DSC instrument. After cooling to the start temperature, 1^{st} and 2^{nd} measurement runs are carried out with inert gas flushing (N₂) of 50 ml/min with a heating rate of 10 K/min, with cooling to the start temperature again between the measurement runs. Measurement takes place customarily in the temperature range from about 50 °C lower than the expected glass transition temperature to about 50 °C higher than the glass transition temperature. The glass transition temperature for the purposes of the present invention, in accordance with DIN 53765, section 8.1, is that temperature in the 2nd measurement run at which half of the change in the specific heat capacity (0.5 delta cₚ) is reached. This temperature is determined from the DSC diagram (plot of the heat flow against the temperature). It is the temperature at the point of intersection of the midline between the extrapolated baselines, before and after the glass transition, with the measurement plot.

### Particle Sizes

The average particle size of spherical polymer particles is determined by dynamic light scattering (photon correlation spectroscopy (PCS)) in accordance with DIN ISO 13321 (Date: October 2004). By average particle size here is meant the measured mean particle diameter (Z-average mean). The measurement uses a Malvern Nano S90 (from Malvern Instruments) at 25±1 °C. The instrument covers a size range from 3 to 3000 nm and is equipped with a 4 mW He—Ne laser at 633 nm. The respective samples are diluted with particle-free deionized water as dispersing medium and then subjected to measurement in a 1 ml polystyrene cell at suitable scattering intensity. Evaluation took place using a digital correlator, with the assistance of the Zetasizer analysis software, version 7.11 (from Malvern Instruments). Measurement takes place five times, and the measurements are repeated on a second, freshly prepared sample. For the aqueous dispersion of the anionically stabilized polymer (asP) the average particle size refers to the arithmetical numerical mean of the measured average particle diameter (Z-average mean; numerical average). For the aqueous dispersion of the anionically stabilized polyurethane-polyurea particles (PPP), the average particle size refers to the arithmetic mean of the average particle size (volume average). The standard deviation of a 5-fold determination here is ≤4%.

For the cellulose nanofibers, the numerical average fiber diameter, length and thus, the calculated aspect ratio are derived from Atomic Force Microscopy (AFM) measurements. A representative sample of CNF is imaged. In the resulting image, diameter and fiber length of at least 100 fibers are determined. The aspect ratio is derived from the ratio of these values.

### Determination of Acid Number

The acid number is determined according to DIN EN ISO 2114 (date: June 2002), using “method A”. The acid number corresponds to the mass of potassium hydroxide in mg which is needed to neutralize 1 g of sample under the conditions stipulated in DIN EN ISO 2114. The reported acid number corresponds here to the total acid number indicated in the DIN standard, and is based on the solids content.

### Determination of OH Number

The OH number is determined according to DIN 53240-2 (date: November 2007). In this method, the OH groups are reacted by acetylation with an excess of acetic anhydride. The excess acetic anhydride is subsequently cleaved to form acetic acid by addition of water, and the total acetic acid is back-titrated with ethanolic KOH. The OH number indicates the amount of KOH in mg (based on the solid) which is equivalent to the amount of acetic acid bound in the acetylation of 1 g of sample.

### Determination of Number-Average and Weight-Average Molecular Weight

The number-average molecular weight (Ms) is determined by gel permeation chromatography (GPC) according to DIN 55672-1 (date: August 2007). Besides the number-average molecular weight, this method can also be used, moreover, for determining the weight-average molecular weight (Mw) and also the polydispersity d (ratio of weight-average molecular weight (M_{w}) to number-average molecular weight (Mn)). Tetrahydrofuran is used as eluent. The determination is made against polystyrene standards. The column material consists of styrene-divinylbenzene copolymers.

### Determination of Gel Fraction of the Polyurethane-Polyurea Particles (PPP)

The gel fraction of the polyurethane-polyurea particles (PPP) is determined gravimetrically in the context of the present invention. Here, first of all, the polymer present was isolated from a sample of an aqueous dispersion (initial mass 1.0 g) by freeze-drying. Following determination of the solidification temperature—the temperature above which the electrical resistance of the sample shows no further change when the temperature is lowered further—the fully frozen sample underwent its main drying, customarily in the drying vacuum pressure range between 5 mbar and 0.05 mbar, at a drying temperature lower by 10 °C than the solidification temperature. By graduated increase in the temperature of the heated surfaces beneath the polymers to 25 °C, rapid freeze-drying of the polymers was achieved; after a drying time of typically 12 hours, the amount of isolated polymer (solid fraction, determined via freeze-drying) was constant and no longer underwent any change even on prolonged freeze-drying. Subsequent drying at a temperature of 30 °C of the surface beneath the polymer, with the ambient pressure reduced to the maximum degree (typically between 0.05 and 0.03 mbar), produced optimum drying of the polymer.

The isolated polymer was subsequently sintered in a forced air oven at 130 °C for 1 minute and thereafter extracted for 24 hours at 25 °C in an excess of tetrahydrofuran (ratio of tetrahydrofuran to solid fraction=300:1). The insoluble fraction of the isolated polymer (gel fraction) was then separated off on a suitable frit, dried in a forced air oven at 50 °C for 4 hours, and subsequently reweighed.

It was further ascertained that at the sintering temperature of 130 °C, with variation in the sintering times between one minute and twenty minutes, the gel fraction found for the particles is independent of the sintering time. It can therefore be ruled out that crosslinking reactions subsequent to the isolation of the polymeric solid increase the gel fraction further.

The gel fraction determined in this way in accordance with the invention is also called gel fraction (freeze-dried).

In parallel a gel fraction, also referred to below as gel fraction (130 °C), was determined gravimetrically by isolating a polymer sample from aqueous dispersion (initial mass 1.0 g) at 130 °C for 60 minutes (solids content). The mass of the polymer was determined, after which the polymer, in analogy to the procedure described above, was extracted in an excess of tetrahydrofuran at 25 °C for 24 hours, the insoluble fraction (gel fraction) was separated off and dried and reweighed.

### Solubility in Water

The solubility of an organic solvent in water at 20 °C was determined as follows. The organic solvent in question and water were combined in a suitable glass vessel and mixed, and the mixture was subsequently equilibrated. The quantities selected here for water and for the solvent were such that the equilibration produced two phases separate from one another. After the equilibration, a syringe is used to take a sample of the aqueous phase (that is, the phase which contains more water than organic solvent), and this sample is diluted in a ratio of 1/10 with tetrahydrofuran and subjected to gas chromatography to ascertain the fraction of the solvent (for conditions see Section 8. Solvent content).

If two phases do not form, irrespective of the amounts of water and the solvent, the solvent is miscible with water in any weight ratio. This therefore infinitely water-soluble solvent (acetone, for example) is therefore at any rate not a solvent (Z.2).

### Determination of the Surface Charges by Means of Electrophoresis

The surface charges were determined by measurements with the Zetasizer Nano from Malvern in the pH range from 3 to 10. The measurements were started at the pH of the samples after dilution. The pH was adjusted using HCl and/or NaOH. The samples were measured in 10 mmol/1 KCl.

### Isocyanate Content

The isocyanate content, also referred to below as NCO content, was determined by adding an excess of a 2% solution of N,N-dibutylamine in xylene to a homogeneous solution of the samples in acetone/N-ethylpyrrolidone (1:1 vol %), using potentiometric back-titration of the excess amine with 0.1 N hydrochloric acid, in a method based on DIN EN ISO 3251, DIN EN ISO 1 1909 and DIN EN ISO 14896. Via the fraction of a polymer (solids content) in solution, it is possible to calculate back to the NCO content of the polymer, based on solids content.

### Degree of Neutralization

The degree of neutralization of a component x was calculated from the amount-of-substance of the carboxylic acid groups present in the component (determined via the acid number) and from the amount-of-substance of the neutralizing agent used.

### Amine Equivalent Mass

The amine equivalent mass (solution) serves for determining the amine content of a solution, and was determined as follows. The sample under investigation was dissolved in glacial acetic acid at room temperature and titrated against 0.1 N perchloric acid in glacial acetic acid, in the presence of crystal violet. From the initial mass of the sample and from the consumption of perchloric acid, the amine equivalent mass (solution) is obtained: the mass of the solution of the basic amine that is needed to neutralize one mol of perchloric acid.

### Degree of Blocking of Primary Amino Groups

The degree of blocking of the primary amino groups was determined by means of IR spectrometry using a Nexus FT-IR spectrometer (from Nicolet) with the aid of an IR cell (d=25 mm, KBr window) at the absorption maximum at 3310 cm⁻¹, on the basis of concentration series of the amines used and standardization to the absorption maximum at 1166 cm⁻¹ (internal standard) at 25 °C.

### Determination of Dry Film Thicknesses (Dry Laver Thicknesses)

The film thicknesses are determined according to DIN EN ISO 2808 (date: May 2007), method 12A, using the MiniTest® 3100-4100 instrument from ElektroPhysik.

### Determination of Flop Index

For determining the lightness or the flop index, a substrate coated accordingly (multicoat system as in Section 5 of the Working Examples below) is subjected to measurement using a spectrophotometer (e.g., X-Rite MA60B+BA Multi-Angle Spectrophotometer). The surface is illuminated with a light source. At various angles, spectral detection is carried out in the visible range. The spectral measurements obtained in this way can be used, taking account of the standardized spectral values and also the reflection spectrum of the light source used, to calculate color values in the CIEL*a*b* color space, where L* characterizes the lightness, a* the red-green value, and b* the yellow-blue value.

This method is described for example in ASTM E2194-12 especially for coatings whose pigment comprises at least one effect pigment. The derived value, often employed for quantifying the so-called metallic effect, is the so-called flop index, which describes the relationship between the lightness and the observation angle. From the lightness values determined for the viewing angles of 15°, 45°, and 110°, it is possible to calculate a flop index (FI_{xRite}) according to the formula

$${FI}_{XRite} = 2.69 \frac{{( {L}_{15}^{*} - {L}_{110}^{*} )}^{1.11}}{{L}_{45}^{* 0.86}}$$

where L* stands for the lightness value measured at the respective measuring angle (150, 450, and 1100).

### Storage Stability Measurements

For determination of storage stability, the coating materials were adjusted using deionized water and dimethylethanolamine to a pH of 8.0 and to a spray viscosity of 100±5 mPa*s under a shearing load of 1000 s⁻¹ as measured using a rotary viscometer (Rheolab QC instrument with C-LTD80/QC conditioning system, from Anton Paar) at 23 °C Further measurements of the viscosity were carried out after a 4-week storage at 23 °C and after a 4-week storage at 40 °C. If the changes in viscosity after storage are small compared to the viscosity of the freshly prepared coating material, the coating materials are considered storage stable.

### WORKING EXAMPLES

The following inventive and comparative examples serve to elucidate the invention, but should not be interpreted as imposing any limitation.

The following should be taken into account regarding the formulation constituents and amounts thereof indicated. When reference is made to a commercial product or to a preparation protocol described elsewhere, the reference, independently of the principal designation selected for the constituent in question, is to precisely this commercial product or precisely the product prepared with the referenced protocol.

Accordingly, where a formulation constituent possesses the principal designation “melamine-formaldehyde resin” and where a commercial product is indicated for this constituent, the melamine-formaldehyde resin is used in the form of precisely this commercial product. Any further constituents present in the commercial product, such as solvents, must therefore be taken into account if conclusions are to be drawn about the amount of the active substance (of the melamine-formaldehyde resin).

If, therefore, reference is made to a preparation protocol for a formulation constituent, and if such preparation results, for example, in a polymer dispersion having a defined nonvolatile fraction, then precisely this dispersion is used. The overriding factor is not whether the principal designation that has been selected is the term “polymer dispersion” or merely the active substance, for example, “polymer”, “polyester”, or “polyurethane-modified polyacrylate”. This must be taken into account if conclusions are to be drawn concerning the amount of the active substance (of the polymer).

### 1. Production of the Polymeric Binders PM

### 1.1 Dispersion D1 of an Anionically Stabilized Polymer

The anionically stabilized polymer (asP) in dispersion in water was prepared as per preparation example “BM2” on pages 63 to 66 of WO 2017/088988 A1. The dispersion D1 at a pH of 8 has an electrophoretic mobility of −2.7 (μm/s)/(V/cm).

### 1.2 Dispersion D2 of Anionically Stabilized Polyurethane-Polyurea Particles (PPP)

The anionically stabilized polyurethane-polyurea particles (PPP) in dispersion in water were prepared as per preparation example “PD1” on pages 75 and 76 of WO 2018/011311 A1. The dispersion D2 at a pH of 8 has an electrophoretic mobility of −6.7 (μm/s)/(V/cm).

### 1.3 Dispersion D3 of Anionically Stabilized Polyurethane Particles

The anionically stabilized polyurethane particles in dispersion in water were prepared as per preparation example H in DE19914055 A1. The dispersion D3 at a pH of 8 has an electrophoretic mobility of −3 (μm/s)/(V/cm).

### 1.4 Dispersion D4

Anionically stabilized polyurethane-modified polyacrylate in water as per preparation example found in DE 4437535 A 1, page 7, line 55 to page 8, line 23.

The dispersion D4 at a pH of 8 has an electrophoretic mobility of −4.2 (μm/s)/(V/cm).

### 2. Preparation of CNF Solution

A cellulose nanofiber solution (CNF solution) was prepared from dry Celluforce NCV-100 by stepwise addition of solid CNF to deionized water while stirring vigorously. After reaching the desired amount of 3 wt.-% CNF in water, stirring was continued until a clear solution was formed.

### 3. Preparation of Filler Pastes and Tinting Pastes

### 3.1 Preparation of a Barium Sulfate Paste F1

The barium sulfate paste F1 is prepared from 54.00 parts by weight of barium sulfate (Blanc Fixe Micro, available from Sachtleben Chemie), 0.3 part by weight of defoamer (Agitan 282, available from Münzing Chemie), 4.6 parts by weight of 2-butoxyethanol, 5.7 parts by weight of deionized water, 3 parts by weight of a polyester (prepared as per example D, column 16, lines 37-59 of DE A 4009858), and 32.4 parts by weight of a polyurethane, by expert grinding and subsequent homogenization.

### 3.2 Preparation of a Talc Paste F2

The talc paste F2 is prepared from 28 parts by weight of talc (Micro Talc IT Extra, available from Mondo Minerals), 0.4 part by weight of defoamer (Agitan 282, available from Münzing Chemie), 1.4 parts by weight of Disperbyk® 184 (available from BYK Chemie, Wesel), 0.6 part by weight of the acrylate thickener Rheovis AS 130 (available from BASF SE), 1 part by weight of 2-butoxyethanol, 3 parts by weight of Pluriol P 900 (available from BASF SE), 18.4 parts by weight of deionized water, 47 parts by weight of an acrylate polymer (binder dispersion A from application WO 91/15528 A1), and 0.2 part by weight of an aqueous dimethylethanolamine solution (10 wt.-% in water), by expert grinding and subsequent homogenization.

### 3.3 Preparation of a White Paste Tinting Paste 1

The white paste is prepared from 50 parts by weight Titan Rutil 2310 (from KRONOS WORLDWIDE, rutile type, produced using the chlorine process), 6 parts by weight of a polyester prepared in DE 40 09 858 A1 (example D, column 16, lines 37-59), 24.7 parts by weight binder dispersion prepared in EP 022 8003 B2 (page 8, lines 6-18), 10.5 parts by weight deionized water, 4 parts by weight 2,4,7,9-tetramethyl-5-decynediol (52% in BG; from BASF SE), 4.1 parts by weight butyl glycol, 0.4 parts by weight 10% dimethylethanolamine in water and 0.3 parts by weight Acrysol RM-8 (from The Dow Chemical Company) by a grinding process.

### 3.4 Preparation of a Black Paste Tinting Paste 2

The black paste is prepared from 57 parts by weight of a polyurethane dispersion prepared as per WO 92/15405, page 13, line 13 to page 15, line 13, 10 parts by weight of carbon black (Monarch® 1400 carbon black from Cabot Corporation), 5 parts by weight of a polyester prepared as per example D, column 16, lines 37-59 of DE 40 09 858 A1, 6.5 parts by weight of a 10% strength aqueous dimethylethanolamine solution, 3 parts by weight of a commercial polyether (Pluriol® P900, available from BASF SE), 7 parts by weight of butyl diglycol, and 11 parts by weight of deionized water.

### 3.5 Preparation of a Yellowish Paste Tinting Paste 3

A yellowish paste was prepared with 49 parts by weight of a polyurethane dispersion prepared according to the binder dispersion A of WO 92/15405, 8.0 parts by weight Disperbyk 184, commercially available from BYK Chemie, 37 parts by weight Bayferrox 3910, commercially available from Lanxess and 6 parts by weight fully desalinated water.

### 3.6 Preparation of a Blue Paste Tinting Paste 4

A red paste was prepared with 52.04 parts by weight of a polyurethane dispersion prepared according to the binder dispersion A of WO 92/15405, 4.0 parts by weight Disperbyk 184, commercially available from BYK Chemie, 0.3 parts by weight of the defoamer Agitan 282, commercially available from Müinzing Chemie, 33.03 parts by weight Heucodur Blue 550, commercially available from Heubach GmbH, 5.6 parts by weight fully desalinated water, 3 parts by weight propylene glycol ether and 3 parts by weight of a polyether Pluriol® P900, commercially available from BASF SE and 2 parts by weight of a 10 wt. % of the acrylic based thickener Rheovis AS 130, BASF SE in demineralized water.

### 4. Production of Aqueous Coating Materials

Unless indicated otherwise, amounts in parts by parts by weight and amounts in percent are in each case percentages by weight.

### 4.1 Production of Waterborne Basecoat Materials BL1* to BL4

To produce the mixing varnish ML, the melamine slurry and the aluminum pigment slurry, the respective components in the table below are homogenized at room temperature. The polycarboxylic acid preparation is produced by homogenizing the non-polymeric polycarboxylic acid in the solvent L and adding the neutralizing agent at room temperature. The polyamide wax dispersion is produced by homogenizing the polyamide at room temperature, with stirring, in the corresponding amount of deionized water.

The waterborne basecoat materials are produced as follows:
(a) the mixing varnish ML is homogenized with the melamine slurry at room temperature,
(b) the ingredients listed under the item “Basecoat Components” in the table are homogenized in succession, in the order stated there, with the mixture obtained according to (a),
(c) the aluminum pigment slurry is incorporated homogeneously into the mixture obtained according to (b), with stirring, at room temperature,
(d) the ingredients listed under the item “Additive Components” in the table are homogeneously incorporated in succession, in the order stated there, into the mixture obtained according to (c), and
(e) the polycarboxylic acid preparation (if contained) is incorporated homogeneously into the mixture obtained according to (d).

The composition is subsequently adjusted using deionized water and dimethylethanolamine to a pH of 7.8 to 8.2 and to a spray viscosity of 100±5 mPa*s under a shearing load of 1000 s⁻¹ as measured using a rotary viscometer (Rheolab QC instrument with C-LTD80/QC conditioning system, from Anton Paar) at 23 °C, in case the viscosity is not already below the afore-mentioned value.

TABLE 1

| | | | |
|---|---|---|---|
| BL1* | BL2 | BL3 | BL4 |

Mixing Varnish ML

| | | | | |
|---|---|---|---|---|
| Na-Mg phyllosilicate suspension (3 wt.-%) | 15 | 0 | 0 | 0 |
| CNF solution (3 wt-%)¹⁶ | 0 | 15 | 7.5 | 3.5 |
| Deionized water | 8 | 0 | 0 | 0 |

| | |
|---|---|
| 2,4,7,9-tetramethyl-5-decynediol¹ | 0.1 |
| Dispersion D1² | 3.5 |

Melamine Slurry

| | |
|---|---|
| Cymel ® 303 LF³ | 4.9 |
| Isotridecyl alcohol | 3.5 |
| Polyester⁴ | 1.55 |

Basecoat Components

| | |
|---|---|
| Dispersion D2⁵ | 18.8 |
| Rheovis ® AS1130 (3 wt.-% in water)⁶ | 1.0 |
| Rheovis ® PU1250 (3 wt.-% in butyl | 0.1 |
| glycol)⁷ | |

Aluminum Pigment Slurry

| | |
|---|---|
| Dispersion D1² | 5.6 |
| Deionized water | 5.0 |
| Rheovis ® AS1130 (3 wt.-% in water)⁶ | 0.1 |
| Dispersing agent Dispex 4437 | 0.3 |
| 2,4,7,9-tetramethyl-5-decynediol¹ | 0.7 |
| Aluminum Pigment 1⁸ | 1.66 |
| Aluminum Pigment 2⁹ | 4.98 |
| Octylphosphonic acid solution (10 wt.-%) | 0.1 |
| Polyester¹⁰ | 3.34 |
| Dimethylethanolamine (10 wt.-% in water) | 0.12 |

Additive Components

| | |
|---|---|
| Talc Paste F2 | 1.3 |
| Barium sulfate paste F1 | 2.5 |
| 2-ethylhexanol | 2.0 |
| K-Flex ud-350w, 88% W¹¹ | 2.7 |
| Tego Wet 510, 100 wt.-%¹² | 0.45 |
| BYK 346¹³ | 0.07 |
| BYK 381¹³ | 0.07 |
| paratoluene sulfonic acid (catalyst) | 0.2 |

Polycarboxylic Acid Preparation

| | |
|---|---|
| Non-polymeric polycarboxylic acid¹⁴ | 0.25 |
| Deionized water | 0.31 |
| Neutralizing agent¹⁵ | 1.45 |

*Comparative Example
¹52 wt.-% in butyl glycol (BASF SE)
²anionically stabilized polymeric binder (aqueous dispersion of anionically stabilized polymer asP)
³melamine-formaldehyd resin
⁴prepared as per example BE1, page 28, II. 13-33 of WO2014/033135
⁵anionically stabilized polymeric binder (aqueous dispersion of anionically stabilized polyurethane-polyurea particles PPP)
⁶BASF SE
⁷BASF SE
⁸Alu-Stapa Hydromic 2156 (65 wt.-% pigment, commercially available from Altana-Eckart)
⁹Alu-Stapa Hydromic 2192 (65 wt.-% pigment, commercially available from Altana-Eckart)
¹⁰prepared as per example D, column 16, II. 37-59 of DE-A-4009858
¹¹commercially available from King Industries
¹²commercially available from Evonik
¹³commercially available from Byk Chemie GmbH
¹⁴dicarboxylic acid of formula (I) wherein R¹ = (CH₂)₄
¹⁵diethanolamine
¹⁶Cellulose Nanofiber (CNF)-solution (3% in water) (commercial name of the fibers: Celluforce NCV-100)

### 4.2 Production of Waterborne Basecoat Materials BL5* to BL10

The waterborne basecoat materials BL5* to BL1=are produced as described in section 4.1. However, the components used were those from the following table (superscript numbers have the same definition as in the table in section 4.1).

TABLE 2

| | | | | | |
|---|---|---|---|---|---|
| BL5* | BL6 | BL7* | BL8* | BL9* | BL10 |

Mixing Varnish ML

| | | | | | | |
|---|---|---|---|---|---|---|
| Na—Mg phyllosilicate suspension | 11.0 | 0 | 17.6 | 0 | 17.6 | 0 |
| (3 wt.-%) | | | | | | |
| CNF solution (3 wt-%)¹⁶ | 0 | 11.0 | 0 | 17.6 | 0 | 17.6 |

| | | | |
|---|---|---|---|
| Deionized water | 3.5 | 0 | 3.7 |

| | | |
|---|---|---|
| 2,4,7,9-tetramethyl-5-decynediol¹ | 1.3 | 0.6 |
| Dispersion D1² | 27.5 | 0 |
| Dispersion D3 | 0 | 25.0 |
| Dispersion D4 | 0 | 2.8 |

Melamine Slurry

| | | |
|---|---|---|
| Cymel ® 203³ | 5.7 | 0 |
| Butyl glycol | 4.7 | 0 |
| Polyester⁴ | 4.0 | 0 |
| Isopropanol | 0 | 1.7 |
| Resimene 755 (from Ineos) | 0 | 3.5 |

Basecoat Components

| | | |
|---|---|---|
| Dispersion D2⁵ | 3.0 | 0 |
| Polypropylenglycol 900-1100 (BASF) | 0.7 | 0.4 |
| 1-propoxy-2-propanol | 1.5 | 0 |
| Rheovis ® AS1130 (3 wt.-% in water)⁶ | 0 | 5.0 |
| Rheovis ® PU1250 (3 wt.-% in butyl | 0 | 0.2 |
| glycol)⁷ | | |
| 2,4,7,9-tetramethyl-5-decynediol¹ | 0 | 0.7 |

Color Pigment Slurry

| | | |
|---|---|---|
| Tinting paste 1 | 26.5 | 0 |
| Tinting paste 2 | 1.6 | 0 |
| Tinting paste 3 | 0.6 | 0 |
| Deionized water | 1.3 | 0 |
| Triisobutylphosphate | 2.0 | 0 |
| Ethylhexanol | 1.0 | 0 |
| Solvent naphtha | 0.5 | 0 |
| Isopar L | 2.0 | 0 |
| Deionized water | 0.8 | 0 |

Effect Pigment Slurry

| | | |
|---|---|---|
| Triisobutylphosphate | 0 | 1.2 |
| Ethylhexanol | 0 | 1.9 |
| Aluminum pigment 1⁸ | 0 | 4.6 |
| Aluminum pigment 2⁹ | 0 | 0.9 |
| Butylglycol | 0 | 3.8 |
| Polyester¹⁰ | 0 | 3.8 |
| Neutralizing agent¹⁵ | 0 | 0.4 |

Additive Components

| | | |
|---|---|---|
| UV absorber | 0 | 0.6 |
| Hindered amine light stabilizer | 0 | 0.4 |
| paratoluene sulfonic acid (catalyst) | 0 | 0.4 |
| DAOTAN TW 6464/36WA (Allnex) | 0 | 4.2 |
| Deionized water | 0 | 2.7 |
| Tinting paste 4 | 0 | 0.6 |
| Deionized water | 0 | 4.0 |

Polycarboxylic Acid Preparation

| | | | | |
|---|---|---|---|---|
| Non-polymeric polycarboxylic acid¹⁴ | 0 | 0.13 | 0 | 0.13 |
| Deionized water | 0 | 0.15 | 0 | 0.15 |
| Neutralizing agent¹⁵ | 0 | 0.73 | 0 | 0.73 |

### 5. Production of Multicoat Paint Systems

### 5.1 Multicoat Paint Systems Using BL1*, BL2, BL3 and BL4

Steel panels coated with a standard cathodic electrocoat material (CathoGuard® 500 gray from BASF Coatings) were coated, using an ESTA bell (ECO Bell 1 from ABB), with a standard commercial surfacer (UniBlock FC737555, available from BASF Coatings GmbH) in two spray passes and, after a flashing time of 10 minutes at 23 °C, the thus coated panels were subsequently cured at 150 °C for 20 minutes; the resulting dry layer thickness was about 35 μm.

Subsequently, using an ESTA bell (ECO Bell 6-F), the respective aqueous basecoat material was applied in two spray passes, with flashing for 45 seconds between each of the spray passes. The panels were then flashed at 23 °C for 10 minutes and subsequently dried at 80 °C for 10 minutes. The resulting overall dry layer thickness of the respective coating material was about 14 μm.

After the basecoat material was dried, a bell (Eco Bell 1) was used to apply a commercial clearcoat material (DuraGloss FF700025, available from BASF Coatings GmbH), which, after a flashing time of 10 minutes at 23 °C, was subsequently cured at 150 °C for 20 minutes; the resulting dry layer thickness was about 40 μm. The layer thicknesses were determined according to DIN EN ISO 2808 (date: May 2007), method 12A, using the MiniTest® 3100-4100 instrument from ElektroPhysik.

5.2 Multicoat Paint Systems Using BL5* or BL6 as 1^{st} Basecoat Material and BL7*, BL9* and BL10 as 2^{nd} Basecoat Material

Steel panels coated with a standard cathodic electrocoat material (CathoGuard® 800 gray from BASF Coatings) were employed.

Using an ESTA bell (EcoBell 3), the first basecoat material was applied. The panels were then flashed at 23 °C for 4 minutes. The resulting overall layer thickness of the respective coating material was about 12 μm.

Afterwards, the second basecoat was applied first using the same ESTA bell type (EcoBell 3) resulting in a layer thickness of about 10 μm. Subsequently, using pneumatic application employing an AGMD Devilbiss bell, a layer of about 4 μm of the second basecoat was applied. Following a flash-off of 4 min at 23 °C, the film was dried at 80 °C for 10 min.

After the basecoat material was dried, a bell (Eco Bell 2) was used to apply a commercial clearcoat material (ProGloss FF990365, available from BASF Coatings GmbH), which, after a flashing time of 5 minutes at 23 °C, was subsequently cured at 140 °C for 20 minutes; the resulting dry layer thickness was about 42 μm.

### 6. Results

### 6.1 Storage Stability

Inventive basecoat materials BL2 (pH: 8; total solids: 30 wt.-%; CNF solids: 0.5 wt.-%), BL3 (pH: 8; total solids: 31 wt.-%; CNF solids: 0.3 wt.-%) and BL4 (pH: 8; total solids 30 wt.-%; CNF solids: 0.16 wt.-%) were subjected to the above-described storage stability testing, the results of which are shown in Table 3 below.

TABLE 3

| | | Viscosity in mPas | | | |
|---|---|---|---|---|---|
| Shear | Storage | (change in % compared to freshly prepared) | | | |
| Rate | Conditions | BL1 | BL2 | BL3 | BL4 |
| 1000 s⁻¹ | freshly | 66 | 98 | 93 | 90 |
| | prepared | | | | |
| | 4 weeks | 73 | 100 | 95 | 86 |
| | (23 °C) | (111%) | (102%) | (102%) | (96%) |
| | 4 weeks | 123 | 106 | 90 | 77 |
| | (40 °C) | (186%) | (108%) | (97%) | (86%) |
| 1 s⁻¹ | freshly | 2900 | 11600 | 11000 | 6300 |
| | prepared | | | | |
| | 4 weeks | 3380 | 13000 | 10200 | 4500 |
| | (23 °C) | (117%) | (112%) | (93%) | (71%) |
| | 4 weeks | 9820 | 9800 | 8000 | 2400 |
| | (40 °C) | (339%) | (84%) | (73%) | (38%) |

Viscosity stability is drastically higher by employing CNF on the one hand compared to lower CNF sol. concentrations (comp. BL4 vs BL3 vs. BL2) but also on the other hand especially comparing to the comparative example BL1. Whereas comparative BL1 shows a viscosity increase after 40 °C storage for 4 weeks of 239%, BL2 shows only a slight change of 16% wherein a measurement error of 10% has to be considered.

Comparative effect pigment containing basecoat material BL7* (pH: 8; total solids: 21.2 wt.-%; CNF solids: 0.0 wt.-%; polycarboxylic acid solids: 0.0 wt.-%), comparative effect pigment containing basecoat material BL8* (pH: 7.9; total solids: 20.9 wt.-%; CNF solids: 0.5 wt.-%; polycarboxylic acid solids: 0.0 wt.-%), comparative effect pigment containing basecoat material BL9* (pH: 7.8; total solids: 19.8 wt.-%; CNF solids: 0.0 wt.-%; polycarboxylic acid solids: 0.1 wt.-%) and inventive effect pigment containing basecoat material BL10 (pH: 8; total solids: 19.4 wt.-%; CNF solids: 0.5 wt.-%; polycarboxylic acid solids: 0.1 wt.-%) were subjected to the above-described storage stability testing, the results of which are shown in Table 4 below.

TABLE 4

| | | Viscosity in mPas | | | |
|---|---|---|---|---|---|
| Shear | Storage | (change in % compared to freshly prepared) | | | |
| Rate | Conditions | BL7* | BL8* | BL9* | BL10 |
| 1000 s⁻¹ | freshly | 100 | 90 | 115 | 123 |
| | prepared | | | | |
| | 4 weeks | 97 | 84 | 117 | 125 |
| | (23 °C) | (97%) | (93%) | (102%) | (102%) |
| | 4 weeks | — | — | 104 | 104 |
| | (40 °C) | | | (90%) | (85%) |
| 1 s⁻¹ | freshly | 4950 | 2380 | 9010 | 7250 |
| | prepared | | | | |
| | 4 weeks | 5000 | 2430 | 9070 | 7700 |
| | (23 °C) | (101%) | (102%) | (101%) | (106%) |
| | 4 weeks | — | — | 5500 | 5620 |
| | (40 °C) | | | (61%) | (78%) |

Comparing BL9 and BL10, viscosity decrease after 4 weeks at 40 °C is lower for CNF-based basecoat. Viscosity decrease is 22% vs. 39% for comparable CNF-free system based on LRD. This implies better stability against sagging for the stored product.

### 6.2 Flop Indices

Comparative basecoat BL1* (pH: 8; total solids: 30 wt.-%; CNF solids: 0.0 wt.-%; polycarboxylic acid solids: 0.3 wt.-%) and inventive basecoat materials BL2 (pH: 8; total solids: 30 wt.-%; CNF solids: 0.5 wt.-%; polycarboxylic acid solids: 0.3 wt.-%), BL3 (pH: 8; total solids: 31 wt.-%; CNF solids: 0.3 wt.-%; polycarboxylic acid solids: 0.3 wt.-%) and BL4 (pH: 8; total solids 30 wt.-%; CNF solids: 0.16 wt.-%; polycarboxylic acid solids: 0.3 wt.-%) were used in the production of multicoat systems as described in Section 5 above. The results are shown in Table 5 below.

TABLE 5
Flop Index

| BL1* | BL2 | BL3 | BL4 |
|---|---|---|---|
| 8.7 | 10.5 | 10.4 | 10.3 |

The above basecoat materials BL2, BL3 and BL4 are used in the same multilayer coating systems and differ just in that they contain different solids amounts of cellulose nanofibers, namely 0.5 wt.-%, 0.3 wt.-% and 0.16 wt.-%, all based on the total weight of the respective basecoat material. Table 5 clearly shows that there is only a small influence of the solids amount of the cellulose nanofibers on the flop index. If at all, even the higher amount used in BL2 does not negatively influence the flop index, to the contrary the flop index is even a little higher compared to BL3 and BL4. Moreover, in all three inventive examples the flop index is increased compared to comparative example BL1* which makes use of a layered metal silicate.

The multicoat layer systems as shown in Table 6 below comprise two basecoat layers and were prepared as detailed in section 5.2 above. The first basecoat material was either a comparative basecoat material BL5* (pH: 8.6; total solids: 34 wt.-%; CNF solids: 0.0 wt.-%; polycarboxylic acid solids: 0.0 wt.-%)—for Examples C1 and C2—or an inventive basecoat material BL6 (pH: 8.4; total solids: 34 wt.-%; CNF solids: 0.3 wt.-%; polycarboxylic acid solids: 0.1 wt.-%)—for Examples 11 and 12.

On top or the first basecoat layer a second basecoat layer was applied wet-on-wet.

The second basecoat layer was either prepared from comparative effect pigment containing basecoat material BL7* (pH: 8.0 total solids: 21.2 wt.-%; CNF solids: 0.0 wt.-%; polycarboxylic acid solids: 0.0 wt.-%)—for Example C1—, comparative effect pigment containing basecoat material BL8* (pH: 7.9; total solids: 20.9 wt.-%; CNF solids: 0.5 wt.-%; polycarboxylic acid solids: 0.0 wt.-%)—for Examples C2 and I1—, or inventive effect pigment containing basecoat material BL10 (pH: 8.0; total solids: 19.4 wt.-%; CNF solids: 0.5 wt.-%; polycarboxylic acid solids: 0.1 wt.-%)—for Example 12.

The results are shown in Table 6 below.

TABLE 6
Multilayer Paint Systems comprising two basecoat layers

| | C1 | C2 | I1 | I2 |
|---|---|---|---|---|
| 1^{st} basecoat | BL5* | BL5* | BL6 | BL6 |
| LMS^{a}/CNF^{b} | LMS | LMS | CNF | CNF |
| Polycarboxylic acid | − | − | + | + |
| 2^{nd} basecoat | BL7* | BL8* | BL8* | BL10 |
| LMS^{a}/CNF^{b} | LMS | CNF | CNF | CNF |
| Polycarboxylic acid | − | − | − | + |
| Flop Index | 14.0 | 14.6 | 15.5 | 16.7 |

*Coating Layer not according to the invention
^{a}Layered Metal Silicate
^{b}Cellulose Nanofiber

In all of the above Examples C1, C2, 11 and 12 only the second basecoat layer contains metal effect pigments, while the first basecoat layer contains only color pigments, but no metal effect pigments (see Table 2).

In comparative Example C1 both layers make use of layered metal silicates (LMS) as rheology control agents and no non-polymeric polycarboxylic acids are contained in any of both basecoat layers. The flop index is, compared to the other examples, the lowest flop index (14.0). In comparative Example C2 the same first basecoat layer as in comparative Example C1 was used, followed by a second basecoat layer containing cellulose nanofibers instead of layered metal silicates, but still lacking the presence of a non-polymeric polycarboxylic acid. The flop index is slightly enhanced (14.6).

Inventive Example 11 shows that the use of an inventive basecoat layer formed from basecoat material BL6 is already and surprisingly apt to increase the flop of the combined two-basecoat-layer architecture, also the metal effect pigment containing layer does not contain a non-polymeric polycarboxylic acid. The flop index is 15.5. Best results are provided in inventive Example 12, were both basecoat layers, the color pigmented and metal effect pigmented layer, contain cellulose nanofibers and a non-polymeric polycarboxylic acid, thus providing a flop index of 16.7.

1. An aqueous coating material comprising
a) one or more polymeric binders;
b) one or more types of cellulose nanofibers; and
c) one or more non-polymeric polycarboxylic acid and/or the salt(s) thereof.

2. The aqueous coating material according to claim 1, further comprising
d) one or more pigments selected from the group consisting of color pigments and effect pigments.

3. The aqueous coating material according to claim 1, characterized in that
one of the one or more polymeric binders comprise one or more anionically stabilized polymeric binders.

4. The aqueous coating material according to claim 1, wherein the one or more types of cellulose nanofibers are selected from the group consisting of anionically modified cellulose nanofibers.

5. The aqueous coating material according to claim 4, wherein the anionically modified cellulose nanofibers comprise sulfate groups.

6. The aqueous coating material according to claim 1, wherein the one or more types of cellulose nanofibers possess a diameter in the range from 2 to 500 nm and a length in the range from 0.04 to 20 μm.

7. The aqueous coating material according to claim 1, wherein the one or more non-polymeric polycarboxylic acids and/or their salts have the following general formula (I)
M⁺⁻OOC—R¹—COO⁻M⁺ (I)
in which
both M⁺ are independently of each other monovalent cations, and
R¹ is not present or is a divalent residue of a saturated or unsaturated, aliphatic or aromatic, linear, branched or cyclic hydrocarbon.

8. The aqueous coating material according to claim 7, wherein the monovalent cation is selected from the group consisting of H⁺, an alkali metal cation, NH₄⁺, and a cation of formula N(R²)₄⁺ wherein residues R² are independently of each other are H, alkyl residues or hydroxyalkyl residues; and
R¹ is not present or comprises 1 to 72 carbon atoms.

9. The aqueous coating material according to claim 2, wherein the one or more color pigments are selected from the group consisting of
(i) white pigments, titanium dioxide, zinc white, zinc sulfide or lithopone;
(ii) black pigments, carbon black, iron manganese black, or spinel black;
(iii) chromatic pigments, ultramarine green, ultramarine blue, manganese blue, ultramarine violet, manganese violet, red iron oxide, molybdate red, ultramarine red, brown iron oxide, mixed brown, spinel phases and corundum phases, yellow iron oxide, or bismuth vanadate;
(iv) organic pigments, monoazo pigments, bisazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, prinone pigments, perylene pigments, phthalocyanine pigments, or aniline black; and
(v) mixtures thereof; and/or
the one or more effect pigments are selected from the group consisting of
(vi) lamellar aluminum pigments, aluminum pigments of “cornflake” and/or “silver dollar” form, aluminum pigments coated with organic pigments,
(vii) glass flakes, glass flakes coated with interference layers,
(viii) gold bronzes, oxidized bronzes, and
(ix) iron oxide-aluminum pigments, pearlescent pigments, metal oxide-mica pigments, lamellar graphite, platelet-shaped iron oxide, multilayer effect pigments composed of PVD films, and mixtures thereof.

10. The aqueous coating material according to claim 1, comprising, based on the total weight of the aqueous coating material,
9 to 60 wt.-% of the one or more polymeric binders;
0.05 to 1.5 wt.-% of the one or more types of cellulose nanofibers; and
0.05 to 5 wt.-% of the one or more non-polymeric polycarboxylic acids and/or the salts thereof.

11. The aqueous coating material according to claim 9 further comprising, based on the total weight of the aqueous coating material,
1 to 40 wt.-% of the one or more color pigments; and/or
1 to 20 wt.-% of the one or more effect pigments.

12. The aqueous coating composition according to claim 1, possessing a solids content in the range from 10 to 65 wt.-%.

13. A method for producing a multicoat paint system on a substrate, the method comprising the following steps:
(1) optionally producing a cured first coating layer on the substrate by application of a coating material to the substrate and subsequent curing of the composition;
(2) producing one or more basecoat layers on the coating layer obtained in step (1) by application of one or more identical or different aqueous basecoat materials;
(3) producing one or more clearcoat layers one the one or the topmost basecoat layer by application of a clearcoat material; and
(4) jointly curing the one or more basecoat layers and the one or more clearcoat layers; wherein
at least one of the basecoat materials is an aqueous coating material according to claim 2.

14. A multilayer coating system obtained by the method according to claim 13.

15. A method of using the aqueous coating material according to claim 1 as a universal aqueous coating composition, the method comprising using the aqueous coating material for the production of pigmented aqueous coating materials.

16. A method of using at least one type of cellulose nanofibers according to claim 1, together with the one or more non-polymeric polycarboxylic acids and/or their salts in an aqueous coating material comprising the one or more polymeric binders and one or more pigments selected from the group consisting of color pigments and effect pigments, the method comprising using the at least one type of cellulose nanofibers in the production of a multilayer coating system.

17. A method of using the pigmented aqueous coating material according to claim 2, the method comprising using the pigmented aqueous coating material as a basecoat material.
